(19) United States
(12) Patent Application Publication
(10) Pub. No.: US 2024/0292366 A1
(43) Pub. Date: Aug. 29, 2024

(54) NETWORK DEVICE, TERMINAL DEVICE, SERVER, AND METHODS THEREIN FOR INDOOR POSITIONING

(71) Applicant: Telefonaktiebolaget LM Ericsson (publ), Stockholm (SE)

(72) Inventor: Lu ZHANG, Beijing (CN)

(73) Assignee: Telefonaktiebolaget LM Ericsson (publ), Stockholm (SE)

(21) Appl. No.: 18/573,546

(22) PCT Filed: May 19, 2022
(86) PCT No.: PCT/CN2022/093880

§ 371 Date: Dec. 22, 2023

(30) Foreign Application Priority Data
Jun. 30, 2021 (WO) PCT/CN2021/103832

(51) Int. Cl. H04W 64/00; H04L 5/00; H04W 24/10

(52) U.S. Cl. CPC H04W 64/00; H04L 5/0051; H04W 24/10

(57) ABSTRACT

The present disclosure provides a method (300) in a Base Band Unit, BBU, in a Digital Indoor System, DIS. The method (300) includes: allocating (310), to each of a plurality of digital headends in a cell, a Positioning Reference Signal, PRS, resource in such a manner that the PRS resources allocated to the plurality of digital headends are orthogonal to each other; and transmitting (320), to each of the plurality of digital headends, a PRS to be transmitted to a terminal device on the PRS resource allocated to the digital headend.

### TECHNICAL FIELD

The present disclosure relates to communication technology, and more particularly, to a network device, a terminal device, a server, and methods therein for indoor positioning.

### BACKGROUND

Positioning, particularly indoor positioning, can be achieved utilizing or without utilizing cellular mobile networks, e.g., the 4^{th} Generation (4G) or Long Term Evolution (LTE) or the 5^{th} Generation (5G) or New Radio (NR) networks.

There are many indoor positioning schemes without utilizing cellular mobile networks (i.e., third-party schemes), including, for example, schemes which exploit some combination of the following technologies: Wireless Fidelity (WiFi) fingerprinting, ZigBee/Bluetooth fingerprinting, geomagnetic fingerprinting, inertial navigation, Radio Frequency Identification (RFID), Ultra Wide Band (UWB) communications, visible light communications, ultrasonic waves, infrared rays, map matching, etc.

For indoor positioning schemes utilizing cellular mobile networks (i.e., cellular-based indoor positioning), a number of traditional positioning methods exist in the latest 4G standards and can be naturally applied to 5G networks, including e.g.:
Enhanced Cell Identification (E-CID): E-CID offers a range of measurements for positioning purposes: Angle-of-Arrival/Departure (AoA/AoD), Received Signal Strength with Path-Loss Model (RSSPLM), Timing Advance type 1 (TADV1, essentially a round trip time) or type 2 (TADV2)
Radio Frequency (RF) pattern matching (or called fingerprinting): This method needs a database of signal fingerprints associated with geographic locations. Typically a fingerprint of a certain geographic location is associated with a signal measurement, such as Received Signal Strength (RSS), for a terminal device or User Equipment (UE). The positioning accuracy of this method depends on the calibration of the database and the quality of the location-dependent measurements
Methods based on ranging measurements: Typically, they are Observed or Uplink Time Difference of Arrival (OTDoA or UTDoA). These two methods use the same principle of measuring Reference Signal Time Difference (RSTD), with Positioning Reference Signal (PRS) for OTDoA and Sounding Reference Signal (SRS) for UTDoA.

The RSTD is a reference signal Time of Arrival (ToA) difference between each base station and a reference base station. A conventional method for estimating a ToA is to find a time delay at which a correlation between a reference signal and a received signal is maximized. When compared to the OTDoA, one major disadvantage of the UTDoA is that it may be difficult for different base stations to receive signals from UEs simply due to transmit power limitations at the UEs.

As satellite signals may be lost in indoor scenarios, indoor positioning schemes do not include Assisted Global Navigation Satellite System (GNSS) (A-GNSS), which is a service that helps GNSS receivers achieve a faster time to first fix (in less than 30 s) by supplying essential information (e.g., almanac and/or ephemeris) through a cellular network data service.

Based on extensive analyses and comparisons (e.g., referring to [1]-[3]), the most preferred cellular-based indoor positioning technology is OTDoA.

Most OTDoA positioning schemes only consider two-dimensional (2-D) positioning. For 2-D positioning, at least three base stations are required such that at least two RSTD measurements can be derived with three ToAs. FIG. 1 shows an example of 2-D positioning, where T₁, τ₂, and τ₃ denote ToAs from three different base stations, respectively, and τ₁-τ₃ and τ₁-τ₃ are RSTDs which give two distance differences representing two hyperbolas, respectively. The intersection of the two hyperbolas corresponds to the UE position. This is also known as trilateration positioning.

Since the hyperbolic equations are nonlinear, several iterative and non-iterative methods (e.g., referring to [4]-[8]) have been developed to solve the problem in order to achieve a maximum-likelihood (ML) or near ML solution.

For some applications, 2-D location information may not be sufficient. For OTDoA based three-dimensional (3-D) positioning, at least four base stations are required to provide three RSTD measurements (e.g., referring to [9]-[14]). Moreover, a number of methods have been proposed to utilize only three base stations to do OTDoA 3-D positioning (e.g., referring to [15]-[16]).

Based on the extensive results under the context of 4G LTE networks, the positioning accuracy of OTDoA can only be typically “<50 m” in a horizontal plane and “<10 m˜50 m (depending on used methods)” in a vertical plane. However, according to the 3^{rd} Generation Partnership Project (3GPP) Technical Report (TR) 22.862, V14.1.0, for 5G NR systems, cellular network based positioning should be supported with accuracy from 10 m to <1 m in 80% of situations, including indoor, outdoor, and urban environments.

Given new technical features in the 5G, the main researches for cellular-based indoor positioning can be classified as:
1) Massive MIMO (mMIMO) channel fingerprint: It makes sense to use large antenna arrays that oversample the spatial dimension of a wireless channel (thus benefiting from, e.g., increased angular resolution, resilience to small-scale fading, and array gain effects) to aid the positioning task. For fingerprinting-based methods, the location is estimated by comparing online measurements with a set of training samples at known locations. One obvious drawback is that pattern features of each location have to be measured prior to positioning, and it may be difficult to distinguish locations with similar pattern features from each other. Also, in dynamic environments, a previously collected pattern might not remain accurate. For emergency positioning, the assumption that most locations already have stored measurements might not be true.
2) More resolvable angle estimation with mMIMO antenna array: A large number of antennas may lead to a high degree of resolvability of angles (e.g., AoA/AoD), by virtue of narrower beams. The most popular methodology for this is to do angle estimation by utilizing Beam-RSRP (BRSRP) measurements and enhanced Kalman filtering. However, to ensure good performance of angle estimation, all of the existing works assume existence of one or more Line of Sight (LoS) paths between base stations and a target UE, which may not be always true.
3) Network densification: In ultra-dense 5G networks, a significant increase in the deployment of the so-called small cells (pico- and femtocells) is expected. This will have a significant role to play in positioning services, since adding more transmitters would increase localization accuracy quite considerably and reduce the effect of synchronization error. Furthermore, cooperative positioning with Device-to-Device (D2D) communications in ultra-dense 5G networks is expected to achieve seamless or ubiquitous positioning with accuracies below one meter. However, the cost involved in maintaining a dense infrastructure by each Mobile Network Operator (MNO) in the same area may not be feasible, due to significantly increased Capital Expenditure (CAPEX) and Operating Expense (OPEX). One possible solution is to make different MNOs cooperate in the process of deploying and maintaining such ultra-dense infrastructure together, but obviously, such infrastructure sharing would raise questions on customer's billing and maintenance cost sharing between the MNOs.

### SUMMARY

In the 5G era, for cellular-based indoor deployment, in addition to keeping the existence of the traditional passive Distributed Antenna System (DAS) already deployed in 4G networks and the so-called active DAS (also referred to as multi-channel joint DAS) newly proposed for 5G, a new feature of Digital Indoor System (DIS) is introduced.

A DIS has a three-layer architecture: digital headend (as “pico-style Radio Remote Unit (pRRU)” or “DoT”), convergence unit (also referred to as “Radio-hub (R-Hub)” or “Indoor Radio Unit (IRU)”), and base band unit (BBU). FIG. 2 shows an exemplary deployment of a DIS. As shown, a BBU 210 is connected to one or more convergence units, e.g., a convergence unit 221 and a convergence unit 222. The convergence unit 221 is connected with digital headends 231˜237 in Cell #1, and the convergence unit 222 is connected with digital headends 241˜244 in Cell #2. The BBU 210 and the digital headends 231-237 and 241˜244 implement baseband and radio functions, respectively.

The convergence units 221 and 222 are introduced to for easy extension and deployment, and not only provide power supply to the digital headends, but also converge data from/to the digital headends so as to reduce the number of interfaces required at the BBU 210. All components in the DIS are connected to carrier digital signals using Ethernet cables or optical fiber cables.

In the DIS, typically a number of digital headends are combined into one cell, which reduces the number of cells such that severe inter-cell interference and frequent handovers could be avoided. In general, one IRU is connected to at least L (L>1) digital headends, while one IRU corresponds to at least M (M≥1) cells. Based on typical requirements from MNOs in China, using digital headends each having two transmitting antennas and two receiving antennas (2T2R) and 100 MHz cell bandwidth as an example, L=8 and M=1 (i.e., each group of L/M=8/1=8 digital headends forms as a cell) is mandatory and L=8 and M=2 (i.e., each group of L/M=8/2=4 digital headends forms as a cell) is optional.

One BBU is connected at most K=N/M (K≥3) IRUs, where N denotes the supported maximum number of cells per BBU. In an example where N=6 and M=1, at most N/M=6/1=6 IRUs can be connected to one BBU.

In fact, due to limitation on the capacity of each BBU and the capacity of transportation (including fronthaul and backhaul), at least for now and recent future, it is impossible to configure each digital headend as a cell. For example, when 6 IRUs are connected to one BBU (each IRU is connected to 8 digital headends), one BBU needs to support 6×8=48 cells. When the 3.5 GHz frequency band is used, as an example, the bandwidth of one cell is at least 100 MHz, and if one BBU needs to support 48 cells, the corresponding capacity requirements on transportation (including fronthaul and backhaul) would be unaffordable.

When each group of L digital headends forms a cell (L=8 for now and possibly L=4 in recent future), although one UE can receive PRSs from three or more digital headends, in most cases those digital headends correspond to only one cell. Thus the PRSs from those digital headends cannot be distinguished from each other and there will be only one, instead of three or more, available positioning-related measurement (e.g., ToA measurement when using OTDoA). That is, the densification of digital headends in the DIS cannot be exploited for OTDoA-based indoor positioning at all, unless i) each digital headend can for a cell (which is infeasible), or ii) a smart mechanism of PRS allocation and transmission can be designed for digital headends that belong to one cell. Currently, aiming at the high-speed train scenario where multiple access points along the railway forms a single cell, some certain way was proposed to differentiate access points belonging to one cell when and only when performing Synchronization Signal and PBCH Block (SSB) transmissions. However, that cannot help to differentiate access points belonging to one cell when performing PRS transmissions, because the resource configurations of SSB and PRS are totally different and irrelevant. In addition, SSB is not designed and will not be used for positioning in 5G systems.

One may consider using UTDoA-based indoor positioning where an SRS transmitted from a UE is measured at each DoT, so that the above problem encountered in OTDoA-based indoor positioning will not occur. However, due to the following reasons, UTDoA is not so suitable for large-scale commercial deployment and has worse positioning accuracy performance than OTDoA:
When the number of UEs that need to use positioning is not so small, as the SRS resources for different UEs need to be orthogonal, either many wireless resources in time-frequency domains are occupied by SRSs for positioning (which is not feasible/affordable for a commercial network) or the UEs need to be put in a waiting list so that the response time of positioning requests is long (which means degraded performance and user experience).
As concluded in [17], the most accurate terrestrial positioning method is OTDoA, which can provide highly accurate positioning in most parts of a cellular network and for most typical environments. The performance of UTDoA may approach that of OTDoA in some deployment scenarios, assuming the use of enhanced uplink receivers, as it may be difficult for enough base stations to receive SRSs from UEs in view of the transmit power limitation at the UE side.
   Here, in an indoor environment, uplink coverage will not be so limited by the UE's transmit power. However, due to the obvious difference between transmit power level of an indoor base station and that of a UE, on average, in a certain DIS deployment, the number of ToA measurements obtained at digital headends via UTDoA will be smaller than that obtained via OTDoA.
   In addition, the number of outdoor macro base stations that may be utilized for positioning will generally be limited in UTDoA.
Generally, in most cases, the response time of positioning request for UTDoA is longer than (i.e., worse than) that for OTDoA [17].

In a word, it will be meaningful and valuable to utilize densification of digital headends in a DIS in OTDoA-based indoor positioning.

It is an object of the present disclosure to provide a network device, a terminal device, a server, and methods therein, capable of providing enhanced indoor positioning.

According to a first aspect of the present disclosure, a method in a BBU in a DIS is provided. The method includes: allocating, to each of a plurality of digital headends in a cell, a PRS resource in such a manner that the PRS resources allocated to the plurality of digital headends are orthogonal to each other; and transmitting, to each of the plurality of digital headends, a PRS to be transmitted to a terminal device on the PRS resource allocated to the digital headend.

In an embodiment, the plurality of digital headends may include a number, L, of digital headends, and the PRS resource allocated to each of the L digital headends in frequency domain may be smaller than or equal to B/L, where B denotes a maximum available bandwidth of the cell.

In an embodiment, the plurality of digital headends may be connected to a convergence unit that is connected to the BBU.

In an embodiment, the method may further include: transmitting, to at least one of the plurality of digital headends, configuration information to be transmitted to the terminal device. The configuration information indicates: PRS resource identifiers (IDs) corresponding to the respective PRS resources allocated to the plurality of digital headends, and time-domain locations and frequency-domain locations of the respective PRS resources.

In an embodiment, the method may further include: receiving, from at least one of the plurality of digital headends, a measurement report. The measurement report contains, for each of one or more of the plurality of the digital headends: a measurement result obtained by the terminal device by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the method may further include: transmitting a report to a positioning server. The report contains, for each of the one or more digital headends: a measurement result obtained by the terminal device by measuring the PRS on the PRS resource allocated to the digital headend, and the PRS resource ID corresponding to the PRS resource.

In an embodiment, the method may further include: transmitting, to the positioning server, an indication of a correspondence between respective digital headend IDs of the plurality of digital headends and the PRS resource IDs.

In an embodiment, the method may further include: transmitting, to a positioning server, a report. The report contains, for each of the one or more of digital headends: the measurement result obtained by the terminal device by measuring the PRS on the PRS resource allocated to the digital headend, and a digital headend ID of the digital headend.

In an embodiment, the measurement report may further contain, for each of one or more further cells: a measurement result obtained by the terminal device by measuring a PRS from a network node of the further cell, and a cell ID of the further cell and/or frequency information associated with the further cell.

In an embodiment, the report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

In an embodiment, the method may further include: updating the respective PRS resources allocated to the plurality of digital headends by means of frequency hopping; and transmitting, to at least one of the plurality of digital headends, an updated configuration to be transmitted to the terminal device. The updated configuration indicates: PRS resource IDs corresponding to the respective updated PRS resources allocated to the plurality of digital headends, and time-domain locations and frequency-domain locations of the respective updated PRS resources.

According to a second aspect of the present disclosure, a BBU is provided. The BBU includes a communication interface, a processor, and a memory. The memory contains instructions executable by the processor whereby the BBU is operative to perform the method according to the above first aspect.

According to a third aspect of the present disclosure, a computer readable storage medium is provided. The computer readable storage medium has computer program instructions stored thereon. The computer program instructions, when executed by a processor in a BBU, cause the BBU to perform the method according to the above first aspect.

According to a fourth aspect of the present disclosure, a method in a digital headend in a cell in a DIS is provided. The method includes: receiving, from a BBU, a resource configuration for allocating, a PRS resource to the digital headend, the PRS source being orthogonal to one or more other PRS resources allocated to one or more other digital headends in the cell; receiving, from the BBU, a PRS to be transmitted to a terminal device; and transmitting, to the terminal device, the PRS on the PRS resource.

In an embodiment, the digital headend may be connected to a convergence unit that is connected to the BBU, and the resource configuration and the PRS may be received from the BBU via the convergence unit.

In an embodiment, the method may further include: receiving, from the BBU, configuration information indicating: a PRS resource identifier, ID, corresponding to the PRS resource allocated to each digital headend in the cell, and a time-domain location and a frequency-domain location of the PRS resource allocated to each digital headend in the cell; and transmitting the configuration information to the terminal device.

In an embodiment, the method may further include: receiving, from the terminal device, a measurement report. The measurement report contains, for each of one or more digital headends in the cell: a measurement result obtained by the terminal device by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the measurement report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

According to a fifth aspect of the present disclosure, a digital headend is provided. The digital headend includes a communication interface, a processor, and a memory. The memory contains instructions executable by the processor whereby the digital headend is operative to perform the method according to the above fourth aspect.

According to a sixth aspect of the present disclosure, a computer readable storage medium is provided. The computer readable storage medium has computer program instructions stored thereon. The computer program instructions, when executed by a processor in a digital headend, cause the digital headend to perform the method according to the above fourth aspect.

According to a seventh aspect of the present disclosure, a method in a terminal device is provided. The method includes: receiving, from at least one of a plurality of digital headends in a cell in a DIS, configuration information, the configuration information indicating PRS resource IDs corresponding to respective PRS resources allocated to the plurality of digital headends and time-domain locations and frequency-domain locations of the respective PRS resources, the respective PRS resources allocated to the plurality of digital headends being orthogonal to each other; measuring a PRS from each of one or more of the plurality of digital headends on the PRS resource allocated to the digital headend; and transmitting, to at least one of the plurality of digital headends, a measurement report containing, for each of the one or more digital headends: a measurement result obtained by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the method may further include: measuring a PRS from a network node of each of one or more further cells. The measurement report may further contain, for each of the one or more further cells: a measurement result obtained by said measuring the PRS from the network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

According to an eighth aspect of the present disclosure, a terminal device is provided. The terminal device includes a communication interface, a processor, and a memory. The memory contains instructions executable by the processor whereby the terminal device is operative to perform the method according to the above seventh aspect.

According to a ninth aspect of the present disclosure, a computer readable storage medium is provided. The computer readable storage medium has computer program instructions stored thereon. The computer program instructions, when executed by a processor in a terminal device, cause the terminal device to perform the method according to the above seventh aspect.

According to a tenth aspect of the present disclosure, a method in a positioning server is provided. The method includes: receiving, from a BBU in a DIS, a report containing, for each of one or more of a plurality of digital headends in a cell, a measurement result obtained by a terminal device by measuring a PRS on a PRS resource allocated to the digital headend, PRS resources allocated to the plurality of digital headends being orthogonal to each other; and determining a position of the terminal device based on the respective measurement results obtained by the terminal device by measuring the PRSs on the respective PRS resources allocated to the one or more digital headends and respective positions of the one or more digital headends.

In an embodiment, the report may further contain, for each of the one or more digital headends, a PRS resource ID corresponding to the PRS resource allocated to the digital headend.

In an embodiment, the method may further include: receiving, from the BBU, an indication of a correspondence between respective digital headend IDs of the plurality of digital headends and PRS resource IDs.

In an embodiment, the report may further contain a digital headend ID of each of the one or more digital headends.

In an embodiment, the method may further include: determining the respective positions of the one or more digital headends based on the respective digital headend IDs of the one or more digital headends.

In an embodiment, the report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

In an embodiment, the position of the terminal device may be determined further based on the measurement results obtained by the terminal device by measuring the PRSs from the respective network nodes of the one or more further cells and respective positions of the network nodes.

In an embodiment, the position of the terminal device may be determined using an OTDoA algorithm.

In an embodiment, the position of the terminal device may be determined based on a weighted average of position estimations each having one of a set of digital headends as a reference for RSTD measurements, using weights dependent on Reference Signal Received Power (RSRP) of the respective PRSs from the set of digital headends as measured at the terminal device. The set of digital headends includes the one or more digital headends, or the one or more digital headends and one or more network nodes of one or more indoor cells among the one or more further cells.

According to an eleventh aspect of the present disclosure, a positioning server is provided.

The positioning server includes a communication interface, a processor, and a memory.

The memory contains instructions executable by the processor whereby the positioning server is operative to perform the method according to the above tenth aspect.

According to a twelfth aspect of the present disclosure, a computer readable storage medium is provided. The computer readable storage medium has computer program instructions stored thereon. The computer program instructions, when executed by a processor in a positioning server, cause the positioning server to perform the method according to the above tenth aspect.

According to a thirteenth aspect of the present disclosure, a network device is provided.

The network device includes the BBU according to the above second aspect and a plurality of digital headends each according to the above fourth aspect.

According to a fourteenth aspect of the present disclosure, a method in a system is provided. The system includes a network device, one or more terminal devices, and a positioning server. The network device includes a BBU and a plurality of digital headends in a cell. The method includes: allocating, by the BBU to each of the plurality of digital headends, a PRS resource in such a manner that the PRS resources allocated to the plurality of digital headends are orthogonal to each other; receiving, by each of the plurality of digital headends from the BBU, a resource configuration indicating the PRS resources allocated to the digital headend; transmitting, by the BBU to each of the plurality of digital headends, a PRS to be transmitted to each of the one or more terminal devices on the PRS resource allocated to the digital headend; receiving, by each of the plurality of digital headends from the BBU, the PRS to be transmitted by the digital headend; transmitting, by each of the plurality of digital headends to each of the one or more terminal devices, the PRS received by the digital headend from the BBU on the PRS resource allocated to the digital headend; measuring, by each of the one or more terminal devices, the PRS from each of one or more of the plurality of digital headends on the PRS resource allocated to the digital headend; transmitting, by each of the one or more terminal devices to at least one of the plurality of digital headends, a measurement report containing, for each of the one or more digital headends: a measurement result obtained by measuring the PRS on the PRS resource allocated to the digital headend, and a PRS resource ID corresponding to the PRS resource; receiving, by the at least one of the plurality of digital headends, the measurement report; forwarding, by the at least one of the plurality of digital headends, the measurement report to the BBU; receiving, by the BBU, the measurement report from the at least one of the plurality of digital headends; transmitting, by the BBU to the positioning server, the report containing, for each of the one or more digital headends: a measurement result obtained by the terminal device by measuring the PRS on the PRS resource allocated to the digital headend, and the PRS resource ID corresponding to the PRS resource; receiving, by the positioning server, the report from the BBU; and determining, by the positioning server, a position of each of the one or more terminal devices based on the respective measurement results obtained by the terminal device by measuring the PRSs on the respective PRS resources allocated to the one or more digital headends and respective positions of the one or more digital headends.

According to a fifteenth aspect of the present disclosure, a system is provided. The system includes a network device, one or more terminal devices, and a positioning server. The network device includes a BBU and a plurality of digital headends in a cell. The BBU is configured to allocate, to each of the plurality of digital headends, a PRS resource in such a manner that the PRS resources allocated to the plurality of digital headends are orthogonal to each other. Each of the plurality of digital headends is configured to receive, from the BBU, a resource configuration indicating the PRS resources allocated to the digital headend. The BBU is further configured to transmit, to each of the plurality of digital headends, a PRS to be transmitted to each of the one or more terminal devices on the PRS resource allocated to the digital headend. Each of the plurality of digital headends is configured to receive, from the BBU, the PRS to be transmitted by the digital headend. Each of the plurality of digital headends is further configured to transmit, to each of the one or more terminal devices, the PRS received by the digital headend from the BBU on the PRS resource allocated to the digital headend. Each of the one or more terminal devices is configured to measure the PRS from each of one or more of the plurality of digital headends on the PRS resource allocated to the digital headend. Each of the one or more terminal devices is further configured to transmit, to at least one of the plurality of digital headends, a measurement report containing, for each of the one or more digital headends: a measurement result obtained by measuring the PRS on the PRS resource allocated to the digital headend, and a PRS resource ID corresponding to the PRS resource. The at least one of the plurality of digital headends is configured to receive the measurement report. The at least one of the plurality of digital headends is further configured to forward the measurement report to the BBU. The BBU is further configured to forward the measurement report from the at least one of the plurality of digital headends. The BBU is further configured to transmit, to the positioning server, the report containing, for each of the one or more digital headends: a measurement result obtained by the terminal device by measuring the PRS on the PRS resource allocated to the digital headend, and the PRS resource ID corresponding to the PRS resource. The positioning server is configured to receive the report from the BBU. The positioning server is further configured to a position of each of the one or more terminal devices based on the respective measurement results obtained by the terminal device by measuring the PRSs on the respective PRS resources allocated to the one or more digital headends and respective positions of the one or more digital headends.

With some embodiments of the present disclosure, a BBU can allocate, to each of a plurality of digital headends in a cell, a PRS resource in such a manner that the PRS resources allocated to the plurality of digital headends are orthogonal to each other.

Accordingly, each digital headend can transmit a PRS to a terminal device on the PRS resource allocated to the digital headend. In this way, without requiring more BBU capacity and more transportation capacity, ToA measurements based on PRSs from different digital headends as fed back from the terminal device can be distinguished from each other based on PRS resource IDs, such that OTDoA can be effectively applied to a DIS, which can lead to the improved positioning accuracy when compared to OTDoA utilizing only outdoor macro cells, since each RSTD here is calculated based on ToA measurements obtained by the terminal device by measuring the PRSs from the digital headends that are located much closer to the terminal device.

Further, with some embodiments of the present disclosure, ToA measurements obtained by the terminal device by measuring PRSs from network nodes of one or more further cells can be further utilized, such that the position of the terminal device can be determined based on ToA measurements obtained by measuring PRSs from one or more digital headends in an indoor serving cell as well as ToA measurements obtained by measuring PRSs from one or more indoor neighboring cells and/or ToA measurements obtained by measuring PRSs from one or more outdoor macro cells. In this way, the number of ToA measurements and therefore the number of RSTD measurements can be much larger when compared to OTDoA utilizing only digital headends in a DIS or OTDoA utilizing only outdoor macro cells, thereby effectively combating ToA errors resulted from Non-LoS bias and further improving the positioning accuracy.

### BRIEF DESCRIPTION OF THE DRAWINGS

The above and other objects, features and advantages will be more apparent from the following description of embodiments with reference to the figures, in which:

FIG. 1 is a schematic diagram showing an example of OTDoA positioning;

FIG. 2 is a schematic diagram showing an exemplary deployment of a DIS;

FIG. 3 is a flowchart illustrating a method in a BBU according to an embodiment of the present disclosure;

FIG. 4 is a schematic diagram showing a configuration of PRS resources according to an embodiment of the present disclosure;

FIG. 5 is a flowchart illustrating a method in a digital headend according to an embodiment of the present disclosure;

FIG. 6 is a flowchart illustrating a method in a terminal device according to an embodiment of the present disclosure;

FIG. 7 is a flowchart illustrating a method in a positioning server according to an embodiment of the present disclosure;

FIG. 8 is a block diagram of a BBU according to an embodiment of the present disclosure;

FIG. 9 is a block diagram of a digital headend according to an embodiment of the present disclosure;

FIG. 10 is a block diagram of a terminal device according to an embodiment of the present disclosure;

FIG. 11 is a block diagram of a positioning server according to an embodiment of the present disclosure;

FIG. 12 is a block diagram of a BBU according to another embodiment of the present disclosure;

FIG. 13 is a block diagram of a digital headend according to another embodiment of the present disclosure;

FIG. 14 is a block diagram of a terminal device according to another embodiment of the present disclosure;

FIG. 15 is a block diagram of a positioning server according to another embodiment of the present disclosure;

FIG. 16 schematically illustrates a telecommunication network connected via an intermediate network to a host computer;

FIG. 17 is a generalized block diagram of a host computer communicating via a base station with a user equipment over a partially wireless connection; and

FIGS. 18 to 21 are flowcharts illustrating methods implemented in a communication system including a host computer, a base station and a user equipment.

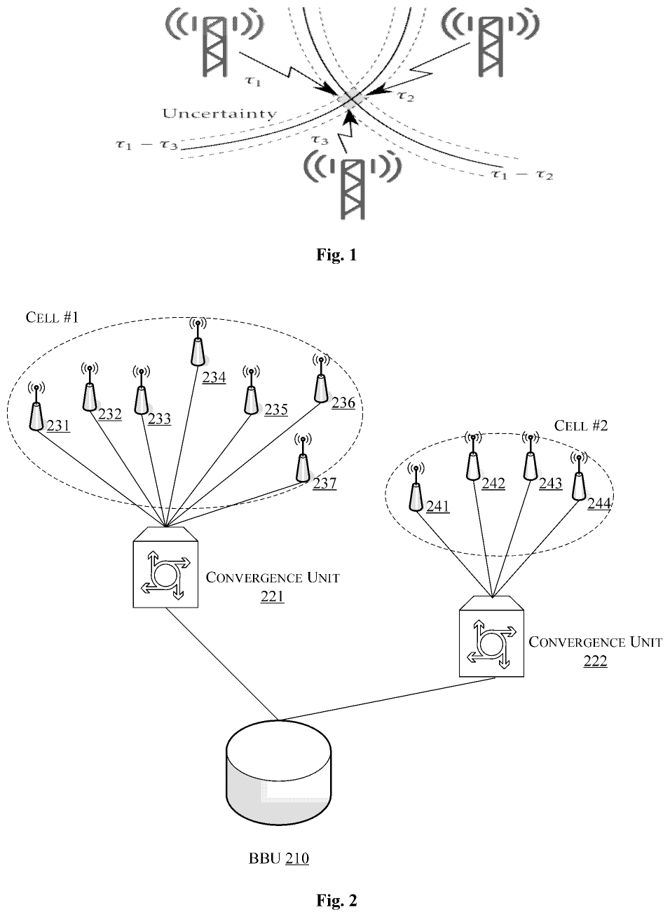

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network node in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable IG (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network node” or “network device” refers to a device in a wireless communication network via which a terminal device accesses the network and receives services therefrom. The network node or network device refers to a base station (BS), an access point (AP), or any other suitable device in the wireless communication network. The BS may be, for example, a node B (NodeB or NB), an evolved NodeB (eNodeB or eNB), or a (next) generation (gNB), a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IOT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink transmission refers to a transmission from the network node to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

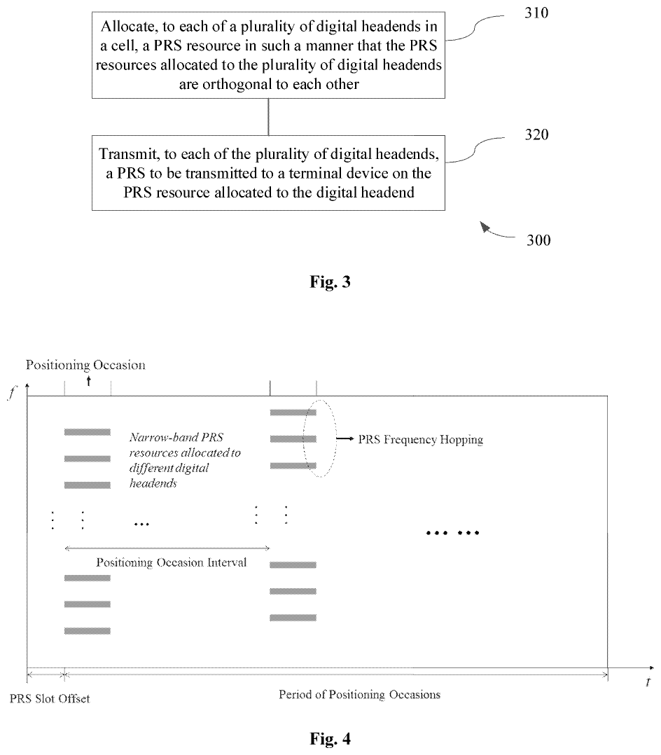

FIG. 3 is a flowchart illustrating a method 300 according to an embodiment of the present disclosure. The method 300 can be performed at a BBU, e.g., in a DIS. For example, the BBU may be the BBU 210 in FIG. 2.

At block 310, the BBU allocates, to each of a plurality of digital headends in a cell, a PRS resource in such a manner that the PRS resources allocated to the plurality of digital headends are orthogonal to each other, e.g., in frequency domain.

For example, the plurality of digital headends may include a number, L, of digital headends, and the PRS resource allocated to each of the L digital headends in frequency domain may be smaller than or equal to B/L, where B denotes a maximum available bandwidth of the cell. In an example, B may be 100 MHz for a 3.5 GHz frequency band. In this sense, the PRS resource allocated to each headend here is a “narrow-band” PRS resource, as opposed to the conventional “wideband” PRS resource that occupies the entire bandwidth of the cell.

In an example, the plurality of L digital headends simultaneously perform PRS transmissions over respective narrow-band PRS resource.

By allocating, to each of the plurality of digital headends in the cell, the PRS resource in the manner that the PRS resources allocated to the plurality of digital headends are orthogonal to each other, e.g., in frequency domain, the simultaneous PRS transmissions from all the digital headends, which forms the cell, will not incur intra-cell PRS interference.

About combating inter-cell PRS interference, when using conventional wideband PRS resource configuration, the existing way is to exploit “comb structure” in frequency, which means that the PRS utilizes every N-th (N=2, 4, 6, or 12) subcarrier of a symbol of a PRB thus allowing N orthogonal PRSs utilizing the same time-domain locations, so that at most 10 subcarrier isolation can be achieved between neighboring cells by using comb-12. But, upon the method in the present disclosure, through using L orthogonal narrow-band PRS resources, at least one subband isolation can be achieved between neighboring cells, therefore achieving obvious enhancement in terms of inter-cell PRS interference mitigation.

In an example, when the BBU performs resource configuration of the L narrow-band PRS resources, besides directly formulating L narrow-band PRS patterns for L orthogonal subbands, another typical way is to perform a “muting” operation in frequency domain for L wideband PRS resources where the i-th (i=1, . . . , L) wideband PRS resource is muted over L−1 subbands except for the i-th subband.

In an example, the plurality of digital headends may be connected to a convergence unit that is connected to the BBU, as shown in FIG. 2 above.

At block 320, the BBU transmits, to each of the plurality of digital headends, a PRS to be transmitted to a terminal device on the PRS resource allocated to the digital headend.

In an example, the BBU may transmit, to at least one of the plurality of digital headends, configuration information to be transmitted to the terminal device. The configuration information indicates: PRS resource IDs corresponding to the respective PRS resources allocated to the plurality of digital headends, and time-domain locations and frequency-domain locations of the respective PRS resources.

In an example, the BBU may receive, from at least one of the plurality of digital headends, a measurement report. The measurement report contains, for each of one or more of the plurality of the digital headends: a measurement result obtained by the terminal device by measuring the PRS on the PRS resource allocated to the digital headend, and the PRS resource ID corresponding to the PRS resource. The measurement report may further contain a cell ID of the cell and/or frequency information (e.g., Absolute Radio Frequency Channel Number (ARFCN)) associated with the cell. Here, each of the one or more digital headends may be a digital headend from which the terminal device receives a PRS.

Then, the BBU may transmit a report to a positioning server, which may be e.g., a Location Management Function (LMF) in a 5G core network or a positioning application server in a Mobile Edge Computing (MEC) platform. The report contains, for each of the one or more digital headends: a measurement result (e.g., ToA measurement) obtained by the terminal device by measuring the PRS on the PRS resource allocated to the digital headend, and the PRS resource ID corresponding to the PRS resource. That is, the BBU can simply forward the received measurement report to the positioning server. For example, the BBU may transmit, to the positioning server, an indication of a correspondence between respective digital headend IDs of the plurality of digital headends and the PRS resource IDs, such that the positioning server can map each PRS resource ID in the report to a digital headend ID.

Alternatively, the BBU may transmit a report to the positioning server and the report may contain, for each of the one or more of digital headends: the measurement result obtained by the terminal device by measuring the PRS on the PRS resource allocated to the digital headend, and a digital headend ID of the digital headend. In this case, the mapping of each PRS resource ID in the measurement report to a digital headend ID can be performed at the BBU.

Here, the respective digital headend IDs of the digital headends are maintained at the BBU and may not be used to identify the digital headends over e.g., an air interface.

In an example, the above measurement report may further contain, for each of one or more further cells: a measurement result (e.g., ToA measurement) obtained by the terminal device by measuring a PRS from a network node of the further cell, and a cell ID of the further cell and/or frequency information (e.g., ARFCN) associated with the further cell. Accordingly, the report transmitted to the positioning server may further contain, for each of one or more further cells: the measurement result obtained by the terminal device by measuring the PRS from the network node of the further cell, and the cell ID of the further cell and/or the frequency information associated with the further cell. Here, the cell and each of the one or more further cells may be intra-frequency cells which may be distinguished from each other based on their respective cell IDs, or inter-frequency cells which may be distinguished from each other based on their respective cell IDs and/or frequency information (e.g., ARFCNs). Each of the one or more further cells may be an indoor cell, and the corresponding network node may be a digital headend. Alternatively, each of the one or more further cells may be an outdoor cell, and the corresponding network node may be e.g., an outdoor macro gNB. In this way, in addition to the PRSs from the plurality of digital headends in the cell, PRSs from further cells (including indoor cells and/or outdoor cells) may be utilized to improve the positioning accuracy.

In an example, the BBU may update the respective PRS resources allocated to the plurality of digital headends by means of frequency hopping, so as to compensate for the loss due to the reduced bandwidth of the narrow-band PRS resources. Accordingly, the BBU may transmit, to at least one of the plurality of digital headends, an updated configuration to be transmitted to the terminal device. The updated configuration indicates: PRS resource IDs corresponding to the respective updated PRS resources allocated to the plurality of digital headends, and time-domain locations and frequency-domain locations of the respective updated PRS resources.

FIG. 4 is a schematic diagram showing a configuration of PRS resources according to an embodiment of the present disclosure. As shown, the PRS resources allocated to different digital headends are orthogonal to each other in the frequency domain. Accordingly, the digital headends can transmit PRSs on the allocated PRS resources in a Frequency Division Multiplexing (FDM) manner. The PRSs are transmitted in N_{occasion} (N_{occasion}>=1) positioning occasions, with each positioning occasion consisting of N_{PRS} (N_{PRS}>=1) consecutive slots. The N_{occasion} positioning occasions occur periodically with a period of T_{PRS} slots. The frequency-domain locations of the PRS resources can be updated by means of frequency hopping from one period to another. When desired to support more frequent PRS transmissions in time, it can be achieved by appropriately increasing N_{occasion}, increasing N_{PRS}, or reducing T_{PRS}. A PRS slot offset can be configured, which defines a starting slot of PRS transmission relative to the start of a system slot cycle.

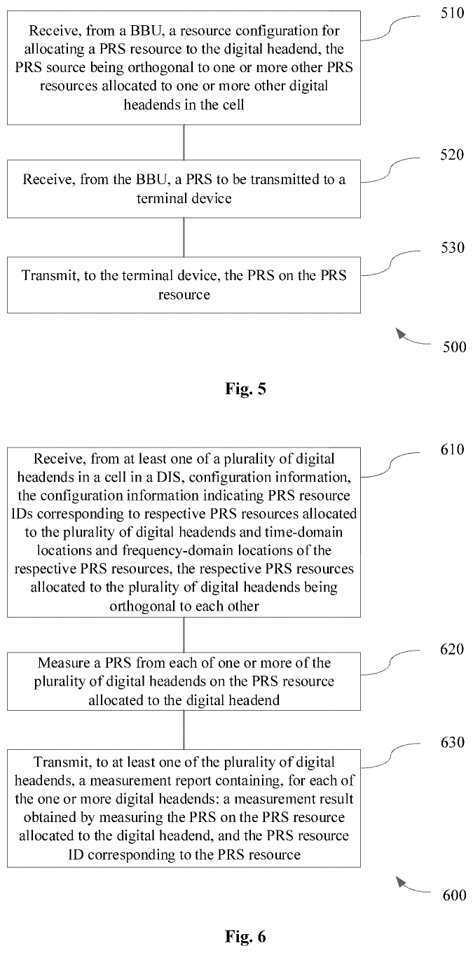

FIG. 5 is a flowchart illustrating a method 500 according to an embodiment of the present disclosure. The method 500 can be performed at a digital headend in a cell, e.g., in a DIS. For example, the digital headend may be any of the digital headends 231˜237 or 241˜244 in FIG. 2.

At block 510, the digital headend receives, from a BBU, a resource configuration for allocating a PRS resource to the digital headend. The PRS source is orthogonal to one or more other PRS resources allocated to one or more other digital headends in the cell, e.g., in frequency domain.

At block 520, the digital headend receives, from the BBU, a PRS to be transmitted to a terminal device.

At block 530, the digital headend transmits, to the terminal device, the PRS on the PRS resource.

In an example, the digital headend may be connected to a convergence unit that is connected to the BBU, as shown in FIG. 2 above. The resource configuration and the PRS may be received from the BBU via the convergence unit.

In an example, the digital headend may receive, from the BBU, configuration information indicating: a PRS resource ID corresponding to the PRS resource allocated to each digital headend in the cell, and a time-domain location and a frequency-domain location of the PRS resource allocated to each digital headend in the cell. The digital headend may then 30 transmit the configuration information to the terminal device.

In an example, the digital headend may receive, from the terminal device, a measurement report. The measurement report contains, for each of one or more digital headends in the cell: a measurement result (e.g., ToA measurement) obtained by the terminal device by measuring the PRS on the PRS resource allocated to the digital headend, and the PRS resource ID corresponding to the PRS resource. The measurement report may further contain a cell ID of the cell and/or frequency information (e.g., ARFCN) associated with the cell. Here, each of the one or more digital headends may be a digital headend from which the terminal device receives a PRS.

In an example, the measurement report may further contain, for each of one or more further cells: a measurement result (e.g., ToA measurement) obtained by the terminal device by measuring a PRS from a network node of the further cell, and a cell ID of the further cell and/or frequency information (e.g., ARFCN) associated with the further cell. Here, the cell and each of the one or more further cells may be intra-frequency cells which may be distinguished from each other based on their respective cell IDs, or inter-frequency cells which may be distinguished from each other based on their respective cell IDs and/or frequency information (e.g., ARFCNs). Each of the one or more further cells may be an indoor cell, and the corresponding network node may be a digital headend. Alternatively, each of the one or more further cells may be an outdoor cell, and the corresponding network node may be e.g., an outdoor macro gNB.

FIG. 6 is a flowchart illustrating a method 600 according to an embodiment of the present disclosure. The method 600 can be performed at a terminal device, e.g., a UE.

At block 610, the terminal device receives, from at least one of a plurality of digital headends in a cell in a DIS, configuration information. The configuration information indicates PRS resource IDs corresponding to respective PRS resources allocated to the plurality of digital headends and time-domain locations and frequency-domain locations of the respective PRS resources. The respective PRS resources allocated to the plurality of digital headends are orthogonal to each other, e.g., in frequency domain.

At block 620, the terminal device measures a PRS from each of one or more of the plurality of digital headends on the PRS resource allocated to the digital headend. Here, each of the one or more digital headends may be a digital headend from which the terminal device receives a PRS.

At block 630, the terminal device transmits, to at least one of the plurality of digital headends, a measurement report. The measurement report contains, for each of the one or more digital headends: a measurement result (e.g., ToA measurement) obtained by measuring the PRS on the PRS resource allocated to the digital headend, and the PRS resource ID corresponding to the PRS resource. In an example, the measurement report may further contain a cell ID of the cell and/or frequency information (e.g., ARFCN) associated with the cell.

In an example, the terminal device may further measure a PRS from a network node of each of one or more further cells. Accordingly, the measurement report may further contains, for each of the one or more further cells: a measurement result (e.g., ToA measurement) obtained by said measuring the PRS from the network node of the further cell, and a cell ID of the further cell and/or frequency information (e.g., ARFCN) associated with the further cell. Here, the cell and each of the one or more further cells may be intra-frequency cells which may be distinguished from each other based on their respective cell IDs, or inter-frequency cells which may be distinguished from each other based on their respective cell IDs and/or frequency information (e.g., ARFCNs). Each of the one or more further cells may be an indoor cell, and the corresponding network node may be a digital headend. Alternatively, each of the one or more further cells may be an outdoor cell, and the corresponding network node may be e.g., an outdoor macro gNB.

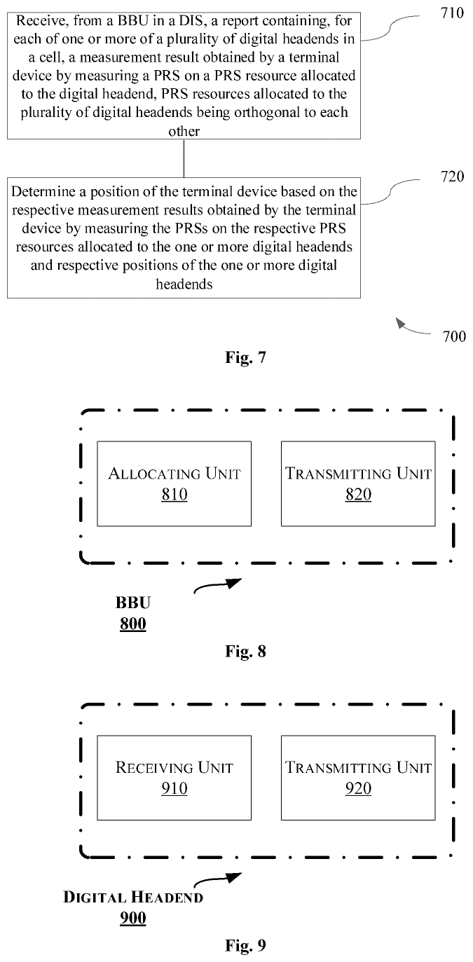

FIG. 7 is a flowchart illustrating a method 700 according to an embodiment of the present disclosure. The method 700 can be performed at a positioning server, e.g., an LMF in a 5G core network or a positioning application server in an MEC platform.

At block 710, the positioning server receives, from a BBU in a DIS, a report. The report contains, for each of one or more of a plurality of digital headends in a cell, a measurement result (e.g., ToA measurement) obtained by a terminal device by measuring a PRS on a PRS resource allocated to the digital headend. PRS resources allocated to the plurality of digital headends are orthogonal to each other, e.g., in frequency domain.

In an example, the report may further contain, for each of the one or more digital headends, a PRS resource ID corresponding to the PRS resource allocated to the digital headend. For example, the positioning server may receive, from the BBU, an indication of a correspondence between respective digital headend IDs of the plurality of digital headends and PRS resource IDs, such that the positioning server can map each PRS resource ID in the report to a digital headend ID.

Alternatively, the report may further contain a digital headend ID of each of the one or more digital headends.

In either case, the positioning server may determine respective positions of the one or more digital headends based on the respective digital headend IDs of the one or more digital headends.

At block 720, the positioning server determines a position of the terminal device based on the respective measurement results obtained by the terminal device by measuring the PRSs on the respective PRS resources allocated to the one or more digital headends and the respective positions of the one or more digital headends.

In an example, the report may further contain, for each of one or more further cells: a measurement result (e.g., ToA measurement) obtained by the terminal device by measuring a PRS from a network node of the further cell, and a cell ID of the further cell and/or frequency information (e.g., ARFCN) associated with the further cell. Here, the cell and each of the one or more further cells may be intra-frequency cells which may be distinguished from each other based on their respective cell IDs, or inter-frequency cells which may be distinguished from each other based on their respective cell IDs and/or frequency information (e.g., ARFCNs). Each of the one or more further cells may be an indoor cell, and the corresponding network node may be a digital headend. Alternatively, each of the one or more further cells may be an outdoor cell, and the corresponding network node may be e.g., an outdoor macro gNB.

In the block 720, the position of the terminal device may be determined further based on the measurement results obtained by the terminal device by measuring the PRSs from the respective network nodes of the one or more further cells and respective positions of the network nodes.

In the block 720, the position of the terminal device may be determined using an OTDoA algorithm.

In particular, for example, the OTDoA algorithm may be performed based on Maximum Likelihood (ML) estimation. It is assumed here that K₁+K₂ ToA measurements are obtained at the terminal device, where K₁ denotes a number of digital headends from each of which the terminal device receives and measures a PRS, and K₂ denotes a number of macro gNBs from each of which the terminal device receives and measures a PRS. It is to be noted here that the K₁ digital headends may belong to one or more indoor cells and the K₂ macro gNBs may belong to one or more outdoor cells. The positioning server can calculate K₁+K₂−1 RSTDs, with the digital headends closest to the terminal device as the only one reference.

Due to several attractive properties, an ML estimator is a popular estimator. The main property of the ML estimator is that it can achieve the Cramer-Rao Lower Bound (CRLB) asymptotically [18, Ch. 7]. The CRLB expresses a lower bound on the variance of any unbiased estimator [18, Ch. 3]. Therefore, as the number of measurements tends to infinity (asymptotic behavior), no unbiased estimator has lower mean squared error than the ML estimator.

The following notation is used throughout the present disclosure. Lowercase and uppercase letters denote scalar values. Bold lowercase and bold uppercase letters denote vectors and matrices, respectively. ∥⋅∥₃ denotes the l₃-norm. diag {a} represents a square diagonal matrix which contains the elements of a on the main diagonal and zeros elsewhere. [A; B] means that matrices A and B are concatenated vertically.

Let [xₖ, yₖ, Zₖ]^{T} denote the known 3-D coordinates of one node (either digital headend or outdoor macro gNB) with an internal node index k (1≤k≤K₁+K₂) from which the terminal device receives a PRS, and let [xᵢ, yₜ, zₜ]^{T} denote the unknown coordinates of the terminal device i. The measured range differences can be obtained by letting all RSTD measurements be multiplied by the speed of light.

Let S denote a set of internal node indices of the K₁+K₂ nodes except the only one reference digital headend. Let m denote the internal node index of the only one reference digital headend. The range-difference measurements can be expressed as:

$${r}_{ik} = {d}_{ik} + {n}_{ik} , k ∈ S$$

where dᵢₖ=∥[xᵢ, yᵢ, zᵢ]^{T}-[xₖ, yₖ, zₖ]^{T}∥₃-∥[xᵢ, yᵢ, z,]^{T}-[xₘ, yₘ, Zₘ]^{T}∥₃, and nᵢₖ represents the measurement error which is typically modelled as Gaussian random variable with variance σ²ᵢₖ.

Denote [xᵢ, yᵢ, zᵢ]^{T} as β. Since the distribution of the considered measurement model is Gaussian, the ML estimator is simply obtained by the following minimization problem [18, Ch. 7]:

$$\hat{β} = {arg min}_{β ∈ {ℝ}^{3}} {( {r}_{i} - {d}_{i} )}^{T} {{Ω}_{i}}^{- 1} ( {r}_{i} - {d}_{i} )$$

where rᵢ are the measurement vectors:

$${r}_{i} = {[ … , {r}_{ik} , … ]}^{T} , k ∈ S ,$$

dᵢ are the model vectors:

$${d}_{i} = {[ … , {d}_{ik} , … ]}^{T} , k ∈ S ,$$

and Ωᵢ are the covariance matrices of the measurements:

$${Ω}_{i} = diag \{ … , {{σ}^{2}}_{ik} , … \} , k ∈ S .$$

The above minimization problem is nonlinear and its closed-form solution is not available. However, it can be approximately solved by iterative numerical techniques such as the Gauss-Newton (GN) algorithm [4], [18]. In the GN algorithm, the nonlinear cost function is linearized by using a first order Taylor series around the global minimum of the cost function. Since the global minimum is unknown, starting with an initial point, the algorithm iteratively tries to find the minimum [18, Ch. 8].

In an example, in the OTDoA algorithm, the position of the terminal device may be determined based on a weighted average of position estimations each having one of a set of digital headends as a reference for RSTD measurements, using weights dependent on Reference Signal Received Power (RSRP) of the respective PRSs from the set of digital headends as measured at the terminal device. The set of digital headends may include the one or more digital headends, or the one or more digital headends and one or more network nodes of one or more indoor cells among the one or more further cells. That is, only the K₁ indoor nodes (digital headends) are selected as reference for RSTD measurements.

In particular, using each of the K₁ digital headends as a reference, K₁ groups of RSTDs will be generated (where each group has K₁+K₂−1 RSTDs).

At Step 1, for every group of K₁+K₂−1 RSTDs, which are resulted by using one of the K₁ digital headends as a reference, one position estimation of the terminal device can be obtained by using any lower-complexity OTDoA 3-D positioning methods (e.g., referred to [5]-[7], [10], or [15]).

Let vₗ (l=1, . . . , K₁) denote K₁ position estimations for [xᵢ, yᵢ, zᵢ]^{T} (i.e., K₁ position estimations for the unknown coordinates of the terminal device i).

Of course, a more complicated ML method (which exploiting first-order Taylor series and some iterative numerical algorithm) can also be used in this step.

At Step 2, a weighted average over K₁ position estimations can be calculated. Here, the weights can be designed based on the RSRP of the respective PRSs from K₁ digital headends as measured at the terminal device, which are denoted as Xₗ (l=1, . . . , K₁).

The weighted average is expressed as:

$${\sum }_{l = 1}^{{K}_{1}} \frac{{X}_{l}}{{\sum }_{1 ∼ {K}_{1}} {X}_{l}} \times {v}_{l}$$

Correspondingly to the method 300 as described above, a BBU is provided. FIG. 8 is a block diagram of a BBU 800 according to an embodiment of the present disclosure.

The BBU 800 is operative to perform the method 300 as described above in connection with FIG. 3. The BBU 800 includes an allocating unit 810 configured to allocate, to each of a plurality of digital headends in a cell, a PRS resource in such a manner that the PRS resources allocated to the plurality of digital headends are orthogonal to each other. The BBU 800 further includes a transmitting unit 820 configured to transmit, to each of the plurality of digital headends, a PRS to be transmitted to a terminal device on the PRS resource allocated to the digital headend.

In an embodiment, the plurality of digital headends may include a number, L, of digital headends, and the PRS resource allocated to each of the L digital headends in frequency domain may be smaller than or equal to B/L, where B denotes a maximum available bandwidth of the cell. In an example, B may be 100 MHz for a 3.5 GHz frequency band. In this sense, the PRS resource allocated to each headend here is a “narrow-band” PRS resource, as opposed to the conventional “wideband” PRS resource that occupies the entire bandwidth of the cell.

In an example, the plurality of L digital headends simultaneously perform PRS transmissions over respective narrow-band PRS resource.

By allocating, to each of the plurality of digital headends in the cell, the PRS resource in the manner that the PRS resources allocated to the plurality of digital headends are orthogonal to each other, e.g., in frequency domain, the simultaneous PRS transmissions from all the digital headends, which forms the cell, will not incur intra-cell PRS interference.

About combating inter-cell PRS interference, when using conventional wideband PRS resource configuration, the existing way is to exploit “comb structure” in frequency, which means that the PRS utilizes every N-th (N=2, 4, 6, or 12) subcarrier of a symbol of a PRB thus allowing N orthogonal PRSs utilizing the same time-domain locations, so that at most 10 subcarrier isolation can be achieved between neighboring cells by using comb-12. But, upon the method in the present disclosure, through using L orthogonal narrow-band PRS resources, at least one subband isolation can be achieved between neighboring cells, therefore achieving obvious enhancement in terms of inter-cell PRS interference mitigation.

In an example, when the BBU 800 performs resource configuration of the L narrow-band PRS resources, besides directly formulating L narrow-band PRS patterns for L orthogonal subbands, another typical way is to perform a “muting” operation in frequency domain for L wideband PRS resources where the i-th (i=1, . . . , L) wideband PRS resource is muted over L−1 subbands except for the i-th subband.

In an embodiment, the plurality of digital headends may be connected to a convergence unit that is connected to the BBU.

In an embodiment, the transmitting unit 820 may be further configured to transmit, to at least one of the plurality of digital headends, configuration information to be transmitted to the terminal device. The configuration information indicates: PRS resource IDs corresponding to the respective PRS resources allocated to the plurality of digital headends, and time-domain locations and frequency-domain locations of the respective PRS resources.

In an embodiment, the BBU 800 may further include a receiving unit configured to receive, from at least one of the plurality of digital headends, a measurement report. The measurement report contains, for each of one or more of the plurality of the digital headends: a measurement result obtained by the terminal device by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the transmitting unit 820 may be further configured to transmit a report to a positioning server. The report contains, for each of the one or more digital headends: a measurement result obtained by the terminal device by measuring the PRS on the PRS resource allocated to the digital headend, and the PRS resource ID corresponding to the PRS resource.

In an embodiment, the transmitting unit 820 may be further configured to transmit, to the positioning server, an indication of a correspondence between respective digital headend IDs of the plurality of digital headends and the PRS resource IDs.

In an embodiment, the transmitting unit 820 may be further configured to transmit, to a positioning server, a report. The report contains, for each of the one or more of digital headends: the measurement result obtained by the terminal device by measuring the PRS on the PRS resource allocated to the digital headend, and a digital headend ID of the digital headend.

In an embodiment, the measurement report may further contain, for each of one or more further cells: a measurement result obtained by the terminal device by measuring a PRS from a network node of the further cell, and a cell ID of the further cell and/or frequency information associated with the further cell.

In an embodiment, the report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

In an embodiment, the allocating unit 810 may be further configured to update the respective PRS resources allocated to the plurality of digital headends by means of frequency hopping. The transmitting unit 820 may be further configured to transmit, to at least one of the plurality of digital headends, an updated configuration to be transmitted to the terminal device. The updated configuration indicates: PRS resource IDs corresponding to the respective updated PRS resources allocated to the plurality of digital headends, and time-domain locations and frequency-domain locations of the respective updated PRS resources.

The units 810 and 820 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 3.

Correspondingly to the method 500 as described above, a digital headend is provided. FIG. 9 is a block diagram of a digital headend 900 according to an embodiment of the present disclosure.

The digital headend 900 is operative to perform the method 500 as described above in connection with FIG. 5. The digital headend 900 includes a receiving unit 910 configured to receive, from a BBU, a resource configuration for allocating, a PRS resource to the digital headend, the PRS source being orthogonal to one or more other PRS resources allocated to one or more other digital headends in the cell. The receiving unit 910 is further configured to receive, from the BBU, a PRS to be transmitted to a terminal device. The digital headend 900 further includes a transmitting unit 920 configured to transmit, to the terminal device, the PRS on the PRS resource.

In an embodiment, the digital headend may be connected to a convergence unit that is connected to the BBU, and the resource configuration and the PRS may be received from the BBU via the convergence unit.

In an embodiment, the receiving unit 910 may be further configured to receive, from the BBU, configuration information indicating: a PRS resource identifier, ID, corresponding to the PRS resource allocated to each digital headend in the cell, and a time-domain location and a frequency-domain location of the PRS resource allocated to each digital headend in the cell. The transmitting unit 920 may be further configured to transmit the configuration information to the terminal device.

In an embodiment, the receiving unit 910 may be further configured to receive, from the terminal device, a measurement report. The measurement report contains, for each of one or more digital headends in the cell: a measurement result obtained by the terminal device by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the measurement report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

The units 910 and 920 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

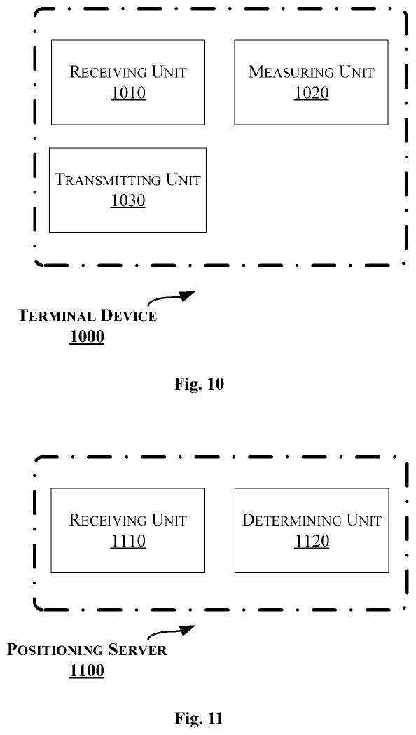

Correspondingly to the method 600 as described above, a terminal device is provided. FIG. 10 is a block diagram of a terminal device 1000 according to an embodiment of the present disclosure.

The terminal device 1000 is operative to perform the method 600 as described above in connection with FIG. 6. The terminal device 1000 includes a receiving unit 1010 configured to receive, from at least one of a plurality of digital headends in a cell in a DIS, configuration information, the configuration information indicating PRS resource IDs corresponding to respective PRS resources allocated to the plurality of digital headends and time-domain locations and frequency-domain locations of the respective PRS resources, the respective PRS resources allocated to the plurality of digital headends being orthogonal to each other. The terminal device 1000 further includes a measuring unit 1020 configured to measure a PRS from each of one or more of the plurality of digital headends on the PRS resource allocated to the digital headend. The terminal device 1000 further includes a transmitting unit 1030 configured to transmit, to at least one of the plurality of digital headends, a measurement report containing, for each of the one or more digital headends: a measurement result obtained by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the measuring unit 1020 may be further configured to measure a PRS from a network node of each of one or more further cells. The measurement report may further contain, for each of the one or more further cells: a measurement result obtained by said measuring the PRS from the network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

The units 1010˜1030 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6.

Correspondingly to the method 700 as described above, a positioning server is provided. FIG. 11 is a block diagram of a positioning server 1100 according to an embodiment of the present disclosure.

The positioning server 1100 is operative to perform the method 700 as described above in connection with FIG. 7. The positioning server 1100 includes a receiving unit 1110 configured to receive, from a BBU in a DIS, a report containing, for each of one or more of a plurality of digital headends in a cell, a measurement result obtained by a terminal device by measuring a PRS on a PRS resource allocated to the digital headend, PRS resources allocated to the plurality of digital headends being orthogonal to each other. The positioning server 1100 further includes a determining unit 1120 configured to determine a position of the terminal device based on the respective measurement results obtained by the terminal device by measuring the PRSs on the respective PRS resources allocated to the one or more digital headends and respective positions of the one or more digital headends.

In an embodiment, the report may further contain, for each of the one or more digital headends, a PRS resource ID corresponding to the PRS resource allocated to the digital headend.

In an embodiment, the receiving unit 1110 may be further configured to receive, from the BBU, an indication of a correspondence between respective digital headend IDs of the plurality of digital headends and PRS resource IDs.

In an embodiment, the report may further contain a digital headend ID of each of the one or more digital headends.

In an embodiment, the determining unit 1120 may be further configured to determine the respective positions of the one or more digital headends based on the respective digital headend IDs of the one or more digital headends.

In an embodiment, the report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

In an embodiment, the position of the terminal device may be determined further based on the measurement results obtained by the terminal device by measuring the PRSs from the respective network nodes of the one or more further cells and respective positions of the network nodes.

In an embodiment, the position of the terminal device may be determined using an OTDoA algorithm.

In an embodiment, the position of the terminal device may be determined based on a weighted average of position estimations each having one of a set of digital headends as a reference for RSTD measurements, using weights dependent on RSRP of the respective PRSs from the set of digital headends as measured at the terminal device. The set of digital headends includes the one or more digital headends, or the one or more digital headends and one or more network nodes of one or more indoor cells among the one or more further cells.

The units 1110 and 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 7.

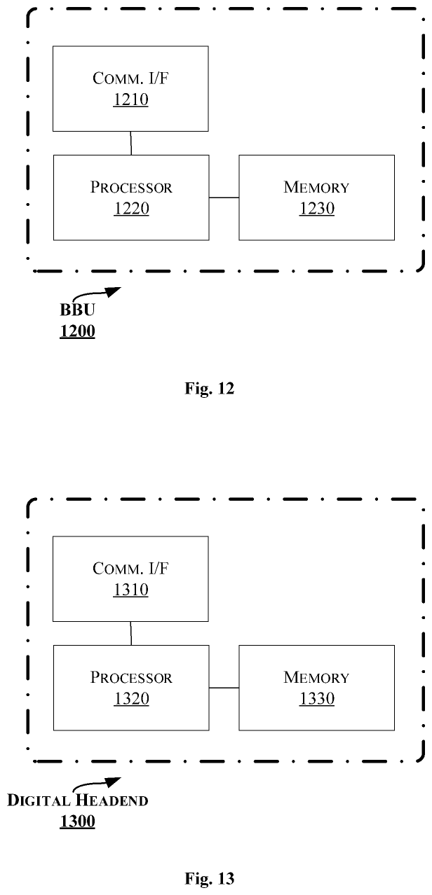

FIG. 12 is a block diagram of a BBU 1200 according to another embodiment of the present disclosure.

The BBU 1200 includes a communication interface 1210, a processor 1220 and a memory 1230. The memory 1230 contains instructions executable by the processor 1220 whereby the BBU 1200 is operative to perform the actions, e.g., of the procedure described earlier in conjunction with FIG. 3. Particularly, the memory 1230 contains instructions executable by the processor 1220 whereby the BBU 1200 is operative to: allocate, to each of a plurality of digital headends in a cell, a PRS resource in such a manner that the PRS resources allocated to the plurality of digital headends are orthogonal to each other; and transmit, to each of the plurality of digital headends, a PRS to be transmitted to a terminal device on the PRS resource allocated to the digital headend.

In an embodiment, the plurality of digital headends may include a number, L, of digital headends, and the PRS resource allocated to each of the L digital headends in frequency domain may be smaller than or equal to B/L, where B denotes a maximum available bandwidth of the cell. In an example, B may be 100 MHz for a 3.5 GHz frequency band. In this sense, the PRS resource allocated to each headend here is a “narrow-band” PRS resource, as opposed to the conventional “wideband” PRS resource that occupies the entire bandwidth of the cell.

In an example, the plurality of L digital headends simultaneously perform PRS transmissions over respective narrow-band PRS resource.

By allocating, to each of the plurality of digital headends in the cell, the PRS resource in the manner that the PRS resources allocated to the plurality of digital headends are orthogonal to each other, e.g., in frequency domain, the simultaneous PRS transmissions from all the digital headends, which forms the cell, will not incur intra-cell PRS interference.

About combating inter-cell PRS interference, when using conventional wideband PRS resource configuration, the existing way is to exploit “comb structure” in frequency, which means that the PRS utilizes every N-th (N=2, 4, 6, or 12) subcarrier of a symbol of a PRB thus allowing N orthogonal PRSs utilizing the same time-domain locations, so that at most 10 subcarrier isolation can be achieved between neighboring cells by using comb-12. But, upon the method in the present disclosure, through using L orthogonal narrow-band PRS resources, at least one subband isolation can be achieved between neighboring cells, therefore achieving obvious enhancement in terms of inter-cell PRS interference mitigation.

In an example, when the BBU 1200 performs resource configuration of the L narrow-band PRS resources, besides directly formulating L narrow-band PRS patterns for L orthogonal subbands, another typical way is to perform a “muting” operation in frequency domain for L wideband PRS resources where the i-th (i=1, . . . , L) wideband PRS resource is muted over L−1 subbands except for the i-th subband.

In an embodiment, the plurality of digital headends may be connected to a convergence unit that is connected to the BBU.

In an embodiment, the memory 1230 may further contain instructions executable by the processor 1220 whereby the BBU 1200 is operative to: transmit, to at least one of the plurality of digital headends, configuration information to be transmitted to the terminal device. The configuration information indicates: PRS resource IDs corresponding to the respective PRS resources allocated to the plurality of digital headends, and time-domain locations and frequency-domain locations of the respective PRS resources.

In an embodiment, the memory 1230 may further contain instructions executable by the processor 1220 whereby the BBU 1200 is operative to: receive, from at least one of the plurality of digital headends, a measurement report. The measurement report contains, for each of one or more of the plurality of the digital headends: a measurement result obtained by the terminal device by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the memory 1230 may further contain instructions executable by the processor 1220 whereby the BBU 1200 is operative to: transmit a report to a positioning server. The report contains, for each of the one or more digital headends: a measurement result obtained by the terminal device by measuring the PRS on the PRS resource allocated to the digital headend, and the PRS resource ID corresponding to the PRS resource.

In an embodiment, the memory 1230 may further contain instructions executable by the processor 1220 whereby the BBU 1200 is operative to: transmit, to the positioning server, an indication of a correspondence between respective digital headend IDs of the plurality of digital headends and the PRS resource IDs.

In an embodiment, the memory 1230 may further contain instructions executable by the processor 1220 whereby the BBU 1200 is operative to: transmit, to a positioning server, a report. The report contains, for each of the one or more of digital headends: the measurement result obtained by the terminal device by measuring the PRS on the PRS resource allocated to the digital headend, and a digital headend ID of the digital headend.

In an embodiment, the measurement report may further contain, for each of one or more further cells: a measurement result obtained by the terminal device by measuring a PRS from a network node of the further cell, and a cell ID of the further cell and/or frequency information associated with the further cell.

In an embodiment, the report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

In an embodiment, the memory 1230 may further contain instructions executable by the processor 1220 whereby the BBU 1200 is operative to: update the respective PRS resources allocated to the plurality of digital headends by means of frequency hopping; and transmit, to at least one of the plurality of digital headends, an updated configuration to be transmitted to the terminal device. The updated configuration indicates: PRS resource IDs corresponding to the respective updated PRS resources allocated to the plurality of digital headends, and time-domain locations and frequency-domain locations of the respective updated PRS resources.

FIG. 13 is a block diagram of a digital headend 1300 according to another embodiment of the present disclosure.

The digital headend 1300 includes a communication interface 1310, a processor 1320 and a memory 1330. The memory 1330 contains instructions executable by the processor 1320 whereby the digital headend 1300 is operative to perform the actions, e.g., of the procedure described earlier in conjunction with FIG. 5. Particularly, the memory 1330 contains instructions executable by the processor 1320 whereby the digital headend 1300 is operative to: receive, from a BBU, a resource configuration for allocating, a PRS resource to the digital headend, the PRS source being orthogonal to one or more other PRS resources allocated to one or more other digital headends in the cell; receive, from the BBU, a PRS to be transmitted to a terminal device; and transmit, to the terminal device, the PRS on the PRS resource.

In an embodiment, the digital headend may be connected to a convergence unit that is connected to the BBU, and the resource configuration and the PRS may be received from the BBU via the convergence unit.

In an embodiment, the memory 1330 may further contain instructions executable by the processor 1320 whereby the digital headend 1300 is operative to: receive, from the BBU, configuration information indicating: a PRS resource identifier, ID, corresponding to the PRS resource allocated to each digital headend in the cell, and a time-domain location and a frequency-domain location of the PRS resource allocated to each digital headend in the cell; and transmit the configuration information to the terminal device.

In an embodiment, the memory 1330 may further contain instructions executable by the processor 1320 whereby the digital headend 1300 is operative to: receive, from the terminal device, a measurement report. The measurement report contains, for each of one or more digital headends in the cell: a measurement result obtained by the terminal device by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the measurement report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

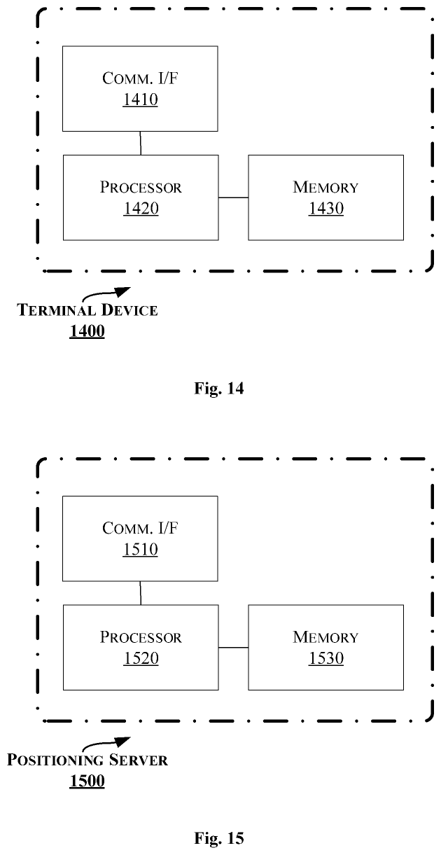

FIG. 14 is a block diagram of a terminal device 1400 according to another embodiment of the present disclosure.

The terminal device 1400 includes a communication interface 1410, a processor 1420 and a memory 1430. The memory 1430 contains instructions executable by the processor 1420 whereby the terminal device 1400 is operative to perform the actions, e.g., of the procedure described earlier in conjunction with FIG. 6. Particularly, the memory 1430 contains instructions executable by the processor 1420 whereby the terminal device 1400 is operative to: receive, from at least one of a plurality of digital headends in a cell in a DIS, configuration information, the configuration information indicating PRS resource IDs corresponding to respective PRS resources allocated to the plurality of digital headends and time-domain locations and frequency-domain locations of the respective PRS resources, the respective PRS resources allocated to the plurality of digital headends being orthogonal to each other; measure a PRS from each of one or more of the plurality of digital headends on the PRS resource allocated to the digital headend; and transmit, to at least one of the plurality of digital headends, a measurement report containing, for each of the one or more digital headends: a measurement result obtained by measuring the PRS on the PRS resource allocated to the digital headend, and the PRS resource ID corresponding to the PRS resource.

In an embodiment, the measurement report may further contain a cell ID of the cell and/or frequency information associated with the cell.

In an embodiment, the memory 1430 may further contain instructions executable by the processor 1420 whereby the terminal device 1400 is operative to: measure a PRS from a network node of each of one or more further cells. The measurement report may further contain, for each of the one or more further cells: a measurement result obtained by said measuring the PRS from the network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

FIG. 15 is a block diagram of a positioning server 1500 according to another embodiment of the present disclosure.

The positioning server 1500 includes a communication interface 1510, a processor 1520 and a memory 1530. The memory 1530 contains instructions executable by the processor 1520 whereby the positioning server 1500 is operative to perform the actions, e.g., of the procedure described earlier in conjunction with FIG. 7. Particularly, the memory 1530 contains instructions executable by the processor 1520 whereby the positioning server 1500 is operative to: receive, from a BBU in a DIS, a report containing, for each of one or more of a plurality of digital headends in a cell, a measurement result obtained by a terminal device by measuring a PRS on a PRS resource allocated to the digital headend, PRS resources allocated to the plurality of digital headends being orthogonal to each other; and determine a position of the terminal device based on the respective measurement results obtained by the terminal device by measuring the PRSs on the respective PRS resources allocated to the one or more digital headends and respective positions of the one or more digital headends.

In an embodiment, the report may further contain, for each of the one or more digital headends, a PRS resource ID corresponding to the PRS resource allocated to the digital headend.

In an embodiment, the memory 1530 may further contain instructions executable by the processor 1520 whereby the positioning server 1500 is operative to: receive, from the BBU, an indication of a correspondence between respective digital headend IDs of the plurality of digital headends and PRS resource IDs.

In an embodiment, the report may further contain a digital headend ID of each of the one or more digital headends.

In an embodiment, the memory 1530 may further contain instructions executable by the processor 1520 whereby the positioning server 1500 is operative to: determine the respective positions of the one or more digital headends based on the respective digital headend IDs of the one or more digital headends.

In an embodiment, the report may further contain, for each of one or more further cells: a measurement result obtained by the terminal device by measuring a PRS from a network node of the further cell, and a cell ID of the further cell and/or frequency information associated with the further cell.

In an embodiment, the cell and each of the one or more further cells may be intra-frequency cells or inter-frequency cells.

In an embodiment, each of the one or more further cells may be an indoor or outdoor cell.

In an embodiment, the position of the terminal device may be determined further based on the measurement results obtained by the terminal device by measuring the PRSs from the respective network nodes of the one or more further cells and respective positions of the network nodes.

In an embodiment, the position of the terminal device may be determined using an OTDoA algorithm.

In an embodiment, the position of the terminal device may be determined based on a weighted average of position estimations each having one of a set of digital headends as a reference for RSTD measurements, using weights dependent on Reference Signal Received Power (RSRP) of the respective PRSs from the set of digital headends as measured at the terminal device. The set of digital headends includes the one or more digital headends, or the one or more digital headends and one or more network nodes of one or more indoor cells among the one or more further cells.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1220 causes the BBU 1200 to perform the actions, e.g., of the procedure described earlier in conjunction with FIG. 3; code/computer readable instructions, which when executed by the processor 1320 causes the digital headend 1300 to perform the actions, e.g., of the procedure described earlier in conjunction with FIG. 5; code/computer readable instructions, which when executed by the processor 1320 causes the terminal device 1400 to perform the actions, e.g., of the procedure described earlier in conjunction with FIG. 6; or code/computer readable instructions, which when executed by the processor 1520 causes the positioning server 1500 to perform the actions, e.g., of the procedure described earlier in conjunction with FIG. 7.

The computer program product may be configured as a computer program code structured in computer program modules. The computer program modules could essentially perform the actions of the flow illustrated in FIG. 3, 5, 6, or 7

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

In an embodiment a method in a system is provided. The system includes a network device, one or more terminal devices, and a positioning server. The network device includes a BBU and a plurality of digital headends in a cell. The method includes: allocating, by the BBU to each of the plurality of digital headends, a PRS resource in such a manner that the PRS resources allocated to the plurality of digital headends are orthogonal to each other; receiving, by each of the plurality of digital headends from the BBU, a resource configuration indicating the PRS resources allocated to the digital headend; transmitting, by the BBU to each of the plurality of digital headends, a PRS to be transmitted to each of the one or more terminal devices on the PRS resource allocated to the digital headend; receiving, by each of the plurality of digital headends from the BBU, the PRS to be transmitted by the digital headend; transmitting, by each of the plurality of digital headends to each of the one or more terminal devices, the PRS received by the digital headend from the BBU on the PRS resource allocated to the digital headend; measuring, by each of the one or more terminal devices, the PRS from each of one or more of the plurality of digital headends on the PRS resource allocated to the digital headend; transmitting, by each of the one or more terminal devices to at least one of the plurality of digital headends, a measurement report containing, for each of the one or more digital headends: a measurement result obtained by measuring the PRS on the PRS resource allocated to the digital headend, and a PRS resource ID corresponding to the PRS resource; receiving, by the at least one of the plurality of digital headends, the measurement report; forwarding, by the at least one of the plurality of digital headends, the measurement report to the BBU; receiving, by the BBU, the measurement report from the at least one of the plurality of digital headends; transmitting, by the BBU to the positioning server, the report containing, for each of the one or more digital headends: a measurement result obtained by the terminal device by measuring the PRS on the PRS resource allocated to the digital headend, and the PRS resource ID corresponding to the PRS resource; receiving, by the positioning server, the report from the BBU; and determining, by the positioning server, a position of each of the one or more terminal devices based on the respective measurement results obtained by the terminal device by measuring the PRSs on the respective PRS resources allocated to the one or more digital headends and respective positions of the one or more digital headends.

In an embodiment, a system is provided. The system includes a network device, one or more terminal devices, and a positioning server. The network device includes a BBU and a plurality of digital headends in a cell. The BBU is configured to allocate, to each of the plurality of digital headends, a PRS resource in such a manner that the PRS resources allocated to the plurality of digital headends are orthogonal to each other. Each of the plurality of digital headends is configured to receive, from the BBU, a resource configuration indicating the PRS resources allocated to the digital headend. The BBU is further configured to transmit, to each of the plurality of digital headends, a PRS to be transmitted to each of the one or more terminal devices on the PRS resource allocated to the digital headend. Each of the plurality of digital headends is configured to receive, from the BBU, the PRS to be transmitted by the digital headend. Each of the plurality of digital headends is further configured to transmit, to each of the one or more terminal devices, the PRS received by the digital headend from the BBU on the PRS resource allocated to the digital headend. Each of the one or more terminal devices is configured to measure the PRS from each of one or more of the plurality of digital headends on the PRS resource allocated to the digital headend. Each of the one or more terminal devices is further configured to transmit, to at least one of the plurality of digital headends, a measurement report containing, for each of the one or more digital headends: a measurement result obtained by measuring the PRS on the PRS resource allocated to the digital headend, and a PRS resource ID corresponding to the PRS resource. The at least one of the plurality of digital headends is configured to receive the measurement report. The at least one of the plurality of digital headends is further configured to forward the measurement report to the BBU. The BBU is further configured to forward the measurement report from the at least one of the plurality of digital headends. The BBU is further configured to transmit, to the positioning server, the report containing, for each of the one or more digital headends: a measurement result obtained by the terminal device by measuring the PRS on the PRS resource allocated to the digital headend, and the PRS resource ID corresponding to the PRS resource. The positioning server is configured to receive the report from the BBU. The positioning server is further configured to a position of each of the one or more terminal devices based on the respective measurement results obtained by the terminal device by measuring the PRSs on the respective PRS resources allocated to the one or more digital headends and respective positions of the one or more digital headends.

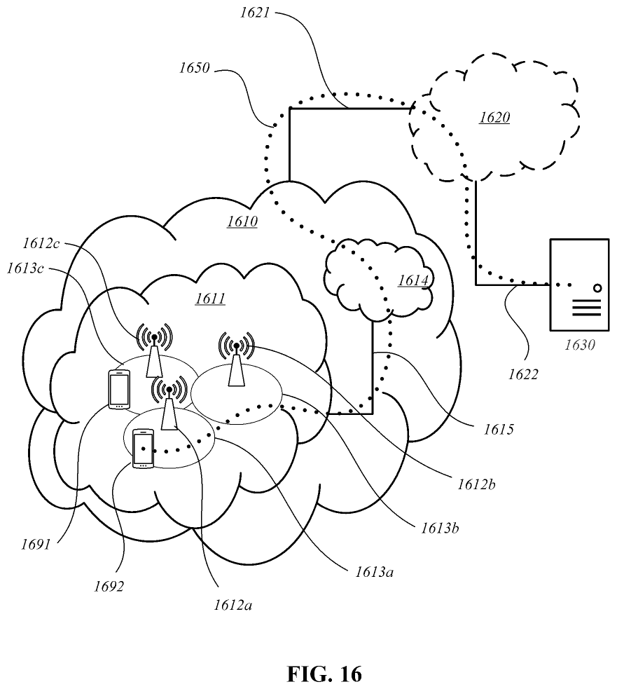

With reference to FIG. 16, in accordance with an embodiment, a communication system includes a telecommunication network 1610, such as a 3GPP-type cellular network, which comprises an access network 1611, such as a radio access network, and a core network 1614. The access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to the core network 1614 over a wired or wireless connection 1615. A first user equipment (UE) 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

The telecommunication network 1610 is itself connected to a host computer 1630, which may be embodied in the hardware and/or software of a standalone server, a cloud-implemented server, a distributed server or as processing resources in a server farm. The host computer 1630 may be under the ownership or control of a service provider, or may be operated by the service provider or on behalf of the service provider. The connections 1621, 1622 between the telecommunication network 1610 and the host computer 1630 may extend directly from the core network 1614 to the host computer 1630 or may go via an optional intermediate network 1620. The intermediate network 1620 may be one of, or a combination of more than one of, a public, private or hosted network; the intermediate network 1620, if any, may be a backbone network or the Internet; in particular, the intermediate network 1620 may comprise two or more sub-networks (not shown).

The communication system of FIG. 16 as a whole enables connectivity between one of the connected UEs 1691, 1692 and the host computer 1630. The connectivity may be described as an over-the-top (OTT) connection 1650. The host computer 1630 and the connected UEs 1691, 1692 are configured to communicate data and/or signaling via the OTT connection 1650, using the access network 1611, the core network 1614, any intermediate network 1620 and possible further infrastructure (not shown) as intermediaries. The OTT connection 1650 may be transparent in the sense that the participating communication devices through which the OTT connection 1650 passes are unaware of routing of uplink and downlink communications. For example, a base station 1612 may not or need not be informed about the past routing of an incoming downlink communication with data originating from a host computer 1630 to be forwarded (e.g., handed over) to a connected UE 1691. Similarly, the base station 1612 need not be aware of the future routing of an outgoing uplink communication originating from the UE 1691 towards the host computer 1630.

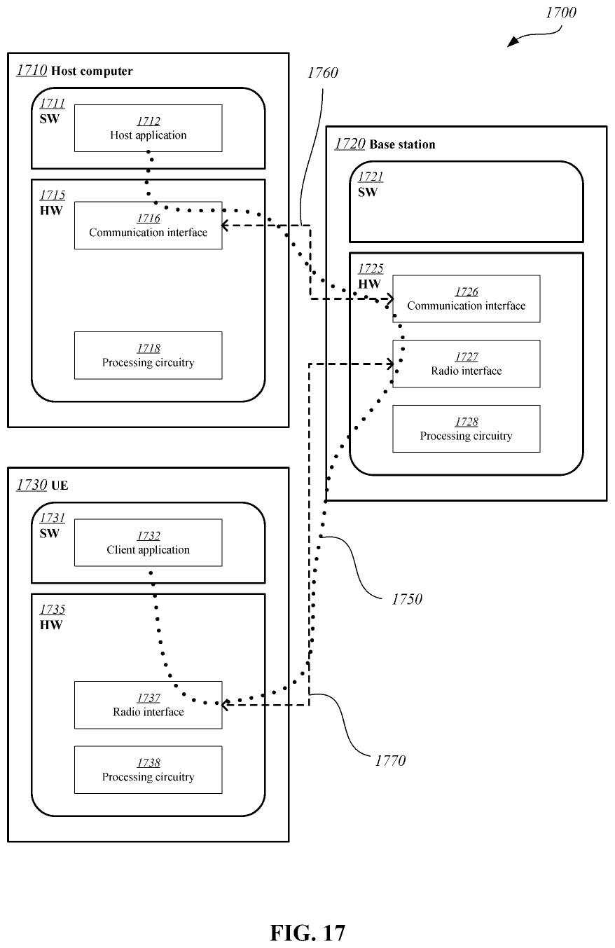

Example implementations, in accordance with an embodiment, of the UE, base station and host computer discussed in the preceding paragraphs will now be described with reference to FIG. 17. In a communication system 1700, a host computer 1710 comprises hardware 1715 including a communication interface 1716 configured to set up and maintain a wired or wireless connection with an interface of a different communication device of the communication system 1700. The host computer 1710 further comprises processing circuitry 1718, which may have storage and/or processing capabilities. In particular, the processing circuitry 1718 may comprise one or more programmable processors, application-specific integrated circuits, field programmable gate arrays or combinations of these (not shown) adapted to execute instructions. The host computer 1710 further comprises software 1711, which is stored in or accessible by the host computer 1710 and executable by the processing circuitry 1718. The software 1711 includes a host application 1712. The host application 1712 may be operable to provide a service to a remote user, such as a UE 1730 connecting via an OTT connection 1750 terminating at the UE 1730 and the host computer 1710. In providing the service to the remote user, the host application 1712 may provide user data which is transmitted using the OTT connection 1750.

The communication system 1700 further includes a base station 1720 provided in a telecommunication system and comprising hardware 1725 enabling it to communicate with the host computer 1710 and with the UE 1730. The hardware 1725 may include a communication interface 1726 for setting up and maintaining a wired or wireless connection with an interface of a different communication device of the communication system 1700, as well as a radio interface 1727 for setting up and maintaining at least a wireless connection 1770 with a UE 1730 located in a coverage area (not shown in FIG. 17) served by the base station 1720. The communication interface 1726 may be configured to facilitate a connection 1760 to the host computer 1710. The connection 1760 may be direct or it may pass through a core network (not shown in FIG. 17) of the telecommunication system and/or through one or more intermediate networks outside the telecommunication system. In the embodiment shown, the hardware 1725 of the base station 1720 further includes processing circuitry 1728, which may comprise one or more programmable processors, application-specific integrated circuits, field programmable gate arrays or combinations of these (not shown) adapted to execute instructions. The base station 1720 further has software 1721 stored internally or accessible via an external connection.

The communication system 1700 further includes the UE 1730 already referred to. Its hardware 1735 may include a radio interface 1737 configured to set up and maintain a wireless connection 1770 with a base station serving a coverage area in which the UE 1730 is currently located. The hardware 1735 of the UE 1730 further includes processing circuitry 1738, which may comprise one or more programmable processors, application-specific integrated circuits, field programmable gate arrays or combinations of these (not shown) adapted to execute instructions. The UE 1730 further comprises software 1731, which is stored in or accessible by the UE 1730 and executable by the processing circuitry 1738. The software 1731 includes a client application 1732. The client application 1732 may be operable to provide a service to a human or non-human user via the UE 1730, with the support of the host computer 1710. In the host computer 1710, an executing host application 1712 may communicate with the executing client application 1732 via the OTT connection 1750 terminating at the UE 1730 and the host computer 1710. In providing the service to the user, the client application 1732 may receive request data from the host application 1712 and provide user data in response to the request data. The OTT connection 1750 may transfer both the request data and the user data. The client application 1732 may interact with the user to generate the user data that it provides.

It is noted that the host computer 1710, base station 1720 and UE 1730 illustrated in FIG. 17 may be identical to the host computer 1630, one of the base stations 1612a, 1612b, 1612c and one of the UEs 1691, 1692 of FIG. 16, respectively. This is to say, the inner workings of these entities may be as shown in FIG. 16 and independently, the surrounding network topology may be that of FIG. 16.

In FIG. 17, the OTT connection 1750 has been drawn abstractly to illustrate the communication between the host computer 1710 and the use equipment 1730 via the base station 1720, without explicit reference to any intermediary devices and the precise routing of messages via these devices. Network infrastructure may determine the routing, which it may be configured to hide from the UE 1730 or from the service provider operating the host computer 1710, or both. While the OTT connection 1750 is active, the network infrastructure may further take decisions by which it dynamically changes the routing (e.g., on the basis of load balancing consideration or reconfiguration of the network).

The wireless connection 1770 between the UE 1730 and the base station 1720 is in accordance with the teachings of the embodiments described throughout this disclosure.

One or more of the various embodiments improve the performance of OTT services provided to the UE 1730 using the OTT connection 1750, in which the wireless connection 1770 forms the last segment. More precisely, the teachings of these embodiments may improve the positioning accuracy and thereby provide benefits such as enhanced location based services.

A measurement procedure may be provided for the purpose of monitoring data rate, latency and other factors on which the one or more embodiments improve. There may further be an optional network functionality for reconfiguring the OTT connection 1750 between the host computer 1710 and UE 1730, in response to variations in the measurement results. The measurement procedure and/or the network functionality for reconfiguring the OTT connection 1750 may be implemented in the software 1711 of the host computer 1710 or in the software 1731 of the UE 1730, or both. In embodiments, sensors (not shown) may be deployed in or in association with communication devices through which the OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of the OTT connection 1750 may include message format, retransmission settings, preferred routing etc.; the reconfiguring need not affect the base station 1720, and it may be unknown or imperceptible to the base station 1720. Such procedures and functionalities may be known and practiced in the art. In certain embodiments, measurements may involve proprietary UE signaling facilitating the host computer's 1710 measurements of throughput, propagation times, latency and the like. The measurements may be implemented in that the software 1711, 1731 causes messages to be transmitted, in particular empty or ‘dummy’ messages, using the OTT connection 1750 while it monitors propagation times, errors etc.

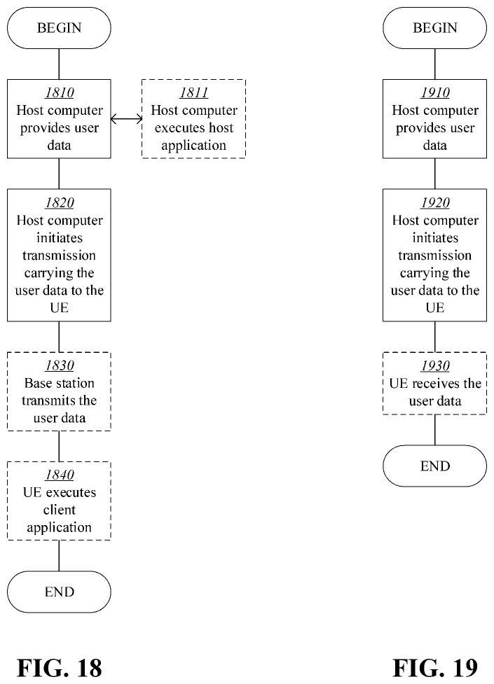

FIG. 18 is a flowchart illustrating a method implemented in a communication system, in accordance with one embodiment. The communication system includes a host computer, a base station and a UE which may be those described with reference to FIGS. 16 and 17.

For simplicity of the present disclosure, only drawing references to FIG. 18 will be included in this section. In a first step 1810 of the method, the host computer provides user data. In an optional substep 1811 of the first step 1810, the host computer provides the user data by executing a host application. In a second step 1820, the host computer initiates a transmission carrying the user data to the UE. In an optional third step 1830, the base station transmits to the UE the user data which was carried in the transmission that the host computer initiated, in accordance with the teachings of the embodiments described throughout this disclosure. In an optional fourth step 1840, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17.

For simplicity of the present disclosure, only drawing references to FIG. 19 will be included in this section. In a first step 1910 of the method, the host computer provides user data. In an optional substep (not shown) the host computer provides the user data by executing a host application. In a second step 1920, the host computer initiates a transmission carrying the user data to the UE. The transmission may pass via the base station, in accordance with the teachings of the embodiments described throughout this disclosure. In an optional third step 1930, the UE receives the user data carried in the transmission.

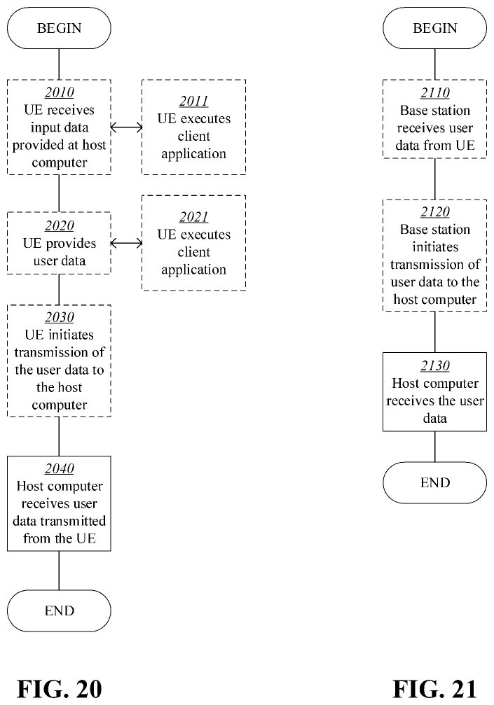

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In an optional first step 2010 of the method, the UE receives input data provided by the host computer. Additionally or alternatively, in an optional second step 2020, the UE provides user data. In an optional substep 2021 of the second step 2020, the UE provides the user data by executing a client application. In a further optional substep 2011 of the first step 2010, the UE executes a client application which provides the user data in reaction to the received input data provided by the host computer. In providing the user data, the executed client application may further consider user input received from the user. Regardless of the specific manner in which the user data was provided, the UE initiates, in an optional third substep 2030, transmission of the user data to the host computer. In a fourth step 2040 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17.

For simplicity of the present disclosure, only drawing references to FIG. 21 will be included in this section. In an optional first step 2110 of the method, in accordance with the teachings of the embodiments described throughout this disclosure, the base station receives user data from the UE. In an optional second step 2120, the base station initiates transmission of the received user data to the host computer. In a third step 2130, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

### REFERENCE LIST

[1] A. Kangas, I. Siomina, and T. Wigren, Handbook of Position Location: Theory, Practice and Advances, R. Zekavat and R. Buehrer, Eds. Piscataway, NJ, USA:Wiley-IEEE Press, 2012.
[2] Study on Indoor Positioning Enhancements, 3GPP TR 37.857 V13.1.0, December 2015.
[3] Z. Chaloupka, “Technology and standardization gaps for high accuracy positioning in 5G,” IEEE Communications Standards Magazine, vol. 1, no. 1, pp. 59-65, March 2017
[4] W. H. Foy, “Position-location solutions by Taylor-series estimation,” IEEE Trans. on Aerospace and Electronic Systems, vol. AES-12, no. 2, pp. 187-194, March 1976.
[5] B. Friedlander, “A passive localization algorithm and its accuracy analysis,” IEEE J. Ocean. Eng., vol. OE-12, no. 1, pp. 234-245, January 1987.
[6] J. O. Smith and J. S. Abel, “Closed-form least-squares source location estimation from range-difference measurements,” IEEE Trans. on Acoust., Speech, Signal Process., vol. ASSP-35, no. 12, pp. 1661-1669, December 1987.
[7] B. T. Fang, “Simple solutions for hyperbolic and related position fixes,” IEEE Trans. on Aerospace and Electronic Systems, vol. 26, no. 5, pp. 748-753, September 1990.
[8] Y. T. Chan and K. C. Ho, “A simple and efficient estimator for hyperbolic location,” IEEE Trans. on Signal Processing, vol. 42, no. 8, pp. 1905-1915, August 1994.
[9] H. Zhang et al., “An improved Taylor series based location algorithm for IEEE 802.15.4a channels,” IEEE Pacific Rim Conf. Commun., Comput. Signal Process., pp. 499-503, August 2011.
[10] Y. T. Chan and K. C. Ho, “Solution and performance analysis of geolocation by TDOA,” IEEE Trans. on Aerospace and Electronic Systems, vol. 29, no. 4, pp. 1311-1322, 1993 October
[11] H. Kong, Y. Kwon, and T. Sung, “Comparisons of TDOA triangulation solutions for indoor positioning,” in Proc. Int. Symp. GNSS, Sydney, Australia, pp. 1-11, December 2004.
[12] Y. Qi, C. B. Soh, E. Gunawan, K.-S. Low, and A. Maskooki, “An accurate 3D UWB hyperbolic localization in indoor multipath environment using iterative Taylor-series estimation,” in Proc. IEEE Veh. Technol. Conf., pp. 1-5, June 2013.
[13] X. Li and S. Yang, “The indoor real-time 3D localization algorithm using UWB,” in Proc. Int. Conf. Adv. Mechatron. Syst., pp. 337-342, August 2015.
[14] R. Langley, “Dilution of precision,” in Proc. GPS World, pp. 52-59, May 1999.
[15] K. Lee, W. Hwang, H. Ryu, and H.-J. Choi, “New TDOA-based three-dimensional positioning method for 3GPP LTE system,” ETRI Journal, vol. 39, no. 2, pp. 264-274, April 2017.
[16] C.-Y. Chen and W.-R. Wu, “Three-dimensional positioning for LTE systems,” IEEE Trans. on Vehicular Technology, vol. 66, no. 4, pp. 3220-3234, April 2017.
[17] Positioning with LTE, Ericsson White Paper, 2011 September
[18] S. M. Kay, Fundamentals of Statistical Signal Processing: Estimation Theory. Upper Saddle River, NJ: Prentice-Hall, 1993.

1. A method in a Base Band Unit (BBU) in a Digital Indoor System (DIS), comprising:
allocating, to each of a plurality of digital headends in a cell, a Positioning Reference Signal (PRS) resource in such a manner that the PRS resources allocated to the plurality of digital headends are orthogonal to each other; and
transmitting, to each of the plurality of digital headends, a PRS to be transmitted to a terminal device on the PRS resource allocated to the digital headend.

2. The method of claim 1, wherein the plurality of digital headends comprise a number, L, of digital headends, and the PRS resource allocated to each of the L digital headends in frequency domain is smaller than or equal to B/L, where B denotes a maximum available bandwidth of the cell.

3. The method of claim 2, wherein the plurality of digital headends are connected to a convergence unit that is connected to the BBU.

4. The method of claim 1, further comprising:
transmitting, to at least one of the plurality of digital headends, configuration information to be transmitted to the terminal device, the configuration information indicating:
PRS resource identifiers, IDs, corresponding to the respective PRS resources allocated to the plurality of digital headends, and
time-domain locations and frequency-domain locations of the respective PRS resources.

5. The method of claim 4, further comprising:
receiving, from at least one of the plurality of digital headends, a measurement report containing, for each of one or more of the plurality of the digital headends:
a measurement result obtained by the terminal device by measuring the PRS on the PRS resource allocated to the digital headend, and
the PRS resource ID corresponding to the PRS resource.

6. The method of claim 5, wherein the measurement report further contains a cell ID of the cell and/or frequency information associated with the cell.

7. The method of claim 5, further comprising:
transmitting a report to a positioning server, the report containing, for each of the one or more digital headends:
a measurement result obtained by the terminal device by measuring the PRS on the PRS resource allocated to the digital headend, and
the PRS resource ID corresponding to the PRS resource.

8. The method of claim 7, further comprising:
transmitting, to the positioning server, an indication of a correspondence between respective digital headend IDs of the plurality of digital headends and the PRS resource IDs.

9. The method of claim 5, further comprising:
transmitting, to a positioning server, a report containing, for each of the one or more of digital headends:
the measurement result obtained by the terminal device by measuring the PRS on the PRS resource allocated to the digital headend, and
a digital headend ID of the digital headend.

10. The method of claim 5, wherein the measurement report further contains, for each of one or more further cells:
a measurement result obtained by the terminal device by measuring a PRS from a network node of the further cell, and
a cell ID of the further cell and/or frequency information associated with the further cell.

11. The method of claim 7, wherein the report further contains, for each of one or more further cells:
a measurement result obtained by the terminal device by measuring a PRS from a network node of the further cell, and
a cell ID of the further cell and/or frequency information associated with the further cell.

12-14. (canceled)

15. A method in a digital headend in a cell in a Digital Indoor System (DIS), comprising:
receiving, from a Base Band Unit (BBU) a resource configuration for allocating a Positioning Reference Signal (PRS) resource to the digital headend, the PRS source being orthogonal to one or more other PRS resources allocated to one or more other digital headends in the cell;
receiving, from the BBU, a PRS to be transmitted to a terminal device; and
transmitting, to the terminal device, the PRS on the PRS resource.

16. The method of claim 15, wherein the digital headend is connected to a convergence unit that is connected to the BBU, and the resource configuration and the PRS are received from the BBU via the convergence unit.

17. The method of claim 15, further comprising:
receiving, from the BBU, configuration information indicating:
a PRS resource identifier, ID, corresponding to the PRS resource allocated to each digital headend in the cell, and
a time-domain location and a frequency-domain location of the PRS resource allocated to each digital headend in the cell; and
transmitting the configuration information to the terminal device.

18. The method of claim 17, further comprising:
receiving, from the terminal device, a measurement report containing, for each of one or more digital headends in the cell:
a measurement result obtained by the terminal device by measuring the PRS on the PRS resource allocated to the digital headend, and
the PRS resource ID corresponding to the PRS resource.

19. The method of claim 18, wherein the measurement report further contains a cell ID of the cell and/or frequency information associated with the cell.

20. The method of claim 18, wherein the measurement report further contains, for each of one or more further cells:
a measurement result obtained by the terminal device by measuring a PRS from a network node of the further cell, and
a cell ID of the further cell and/or frequency information associated with the further cell.

21. The method of claim 20, wherein the cell and each of the one or more further cells are intra-frequency cells or inter-frequency cells.

22. The method of claim 20, wherein each of the one or more further cells is an indoor or outdoor cell.

23. A method in a terminal device, comprising:
receiving, from at least one of a plurality of digital headends in a cell in a Digital Indoor System, DIS, configuration information, the configuration information indicating Positioning Reference Signal (PRS) resource identifiers, IDs, corresponding to respective PRS resources allocated to the plurality of digital headends and time-domain locations and frequency-domain locations of the respective PRS resources, the respective PRS resources allocated to the plurality of digital headends being orthogonal to each other;
measuring a PRS from each of one or more of the plurality of digital headends on the PRS resource allocated to the digital headend; and
transmitting, to at least one of the plurality of digital headends, a measurement report containing, for each of the one or more digital headends:
a measurement result obtained by measuring the PRS on the PRS resource allocated to the digital headend, and
the PRS resource ID corresponding to the PRS resource.

24-49. (canceled)
